(19) United States
(12) Patent Application Publication
(10) Pub. No.: US 2010/0010851 A1
(43) Pub. Date: Jan. 14, 2010

(54) REAL ESTATE SPACE EVALUATION SYSTEM AND METHOD

(76) Inventor: MICHAEL WALKER, Oak Brook, IL (US)

Correspondence Address: PATENT GROUP;C/O DLA PIPER US LLP, 203 N. LASALLE ST., SUITE 1900, CHICAGO, IL, 60601, US

(21) Appl. No.: 12/172,602

(22) Filed: Jul. 14, 2008

(51) Int. Cl. G06F 19/00; G06F 17/00

(52) U.S. Cl. 705/7; 705/412

(57) ABSTRACT

A system and method for allowing users of real estate to calculate the relative costs of various office space area sizes so an educated decision can be made early in the real estate leasing and purchasing processes, thus eliminating potential additional work necessary caused by adjustments to space requirements midway through a relocation. The system also allows the user to create a detailed description of the construction that will be required for that space so an accurate construction estimate can be obtained.

### FIELD OF THE INVENTION

The invention relates generally to commercial real estate leasing and, more particularly, to a system and method for determining the amount of space a user should require in commercial real estate office buildings and the like.

### BACKGROUND

Tenants who use office space (either by lease or ownership) typically pay for that space on a quantity basis which is most often divided into square foot increments for rent and purchase calculation purposes. Additionally, many users of office space are working within budgets for the expense attributable for the use of this real estate.

Additionally, the real estate and architectural industries currently lack any scientific way of accurately estimating the amount of space that a user of office space should require. The two industries use antiquated methods of estimating user requirements that in most cases are paramount to nothing more than a guess (i.e. 250 rentable square feet per person). Additionally, the current process for estimating appropriate square footages is made more difficult because the industries have failed to identify that each office building has a set of unique characteristics that create inefficiencies when designing a user's requirements for a particular office building. These inefficiencies will cause a user to require more square feet at a building with more of these inefficiency characteristics than at a building with less of them . . . even though the user's base requirements are identical for both.

A user may also have difficulty in projecting the correct amount of space because not all architects, designers or space planners (collectively referred to as “space planners”) are consistent with their methods of designing the requirements of a user into a particular area. For example, the exact same programming requirements for a user in the exact same office building might take one space planner 10,000 square feet to design and another space planner 11,000 square feet to design.

A user of office space who is considering relocation is typically asked to identify their space requirements in advance of knowing how much space will be required to lay out those requirements. This makes sense because it is typical for the architectural industry to create space plans based on that user's list of requirements (otherwise known as a “Space Program”). Additionally, a user must typically identify the quality of building (and associated rental rate range) before their space plan is prepared. It is hard for that user to project the areas and sizes of office space requirements as well as the quality and price of buildings to consider this early in the process. This is because there is currently no system that accurately converts their Space Program into a usable square foot quantity, or further considers differences in building inefficiencies that will affect the total amount of space required from building to building. This makes if very difficult for the user to know the quality of building they can afford, while staying within their budget.

The reasons for the difficulties as identified above are: 1) there is no current method of scientifically identifying the correlation between the net usable square footage of an area (for example, a 10′×15′ office of 150 net usable square feet) and the ultimate rentable square feet required for that space, 2) a user's Space Program may be designed to fit in varying amounts of rentable space by different space planners and 3) a user's space may require varying amounts of space from one building to another because of inefficiencies related to that building.

These unknown variables create problems for the user. On one hand, the user may be too conservative with their Space Program because they are uncertain of how much area that Program will actually require on a rentable basis. This may cause them to either not project as much space as they would like, or to only consider moving to buildings that have a lesser rental rate (and lesser quality), when in fact their budget may have allowed them to be in a higher quality building or to increase sizes or quantity of various areas within their Space Program.

On the other hand, the user may oversize their office requirements (i.e. pick larger areas then their budget actually allows), not fully understanding the correlation between net usable square footage and gross rentable square footage. If they make this mistake, the excessive amount of space they have identified in their Space Program may force them to either reduce the quality of the office building they consider or restart the project in the middle of the transaction to adjust the Space Program, wasting all the time and expense spent on the project to date.

Additionally, for users of office space that have more than one location, the difficulties in ensuring the correct amount of space is leased are increased dramatically. These difficulties result in inconsistent sizing from office to office and add tremendous additional costs for national/multi-location users. There are many reasons that make it difficult for these users to keep consistency throughout their portfolio.

First, these users, hereinafter described as “multi-location” users, may have anywhere between 2 and 1000 offices nationally and each of those offices may, and often do, have varying requirements. Unless a new Space Program is created for each location, inefficiencies creep into the eventual design of the space. Since creating these Space Programs can be time consuming, it is no wonder that the architectural and commercial real estate industries tend to settle for a “rule of thumb” when estimating a user's required square footage. These rule of thumb estimates are not very accurate and tend to lead to leasing (or purchasing) too much space.

Another difficulty for multi-location office users in projecting the amount of space that may be required for any particular office is the fact that, in many instances, a different space planner is used from location to location. As identified earlier, space planners all have somewhat different methods of laying out their space, and different space planners will use different amounts of space to lay out the same requirements. This makes consistently projecting the right amount of space from office to office very difficult.

Moreover, since it has been determined that each building has characteristics that make it more or less efficient than another competing building, the task of properly identifying the correct amount of square footage that should be required becomes even more difficult for multi-location users.

Lastly, a problem exists for multi-location companies in maintaining consistency from office location to office location. These inconsistencies come from a number of different areas. First, being able to document and administer the sizes of various office areas from office to office is a time consuming task. Aside from the effort required to consistently document a detailed Space Program from office to office, inter company politics often play a factor in sizing the various office areas, leading to inconsistency from office to office in what should otherwise be consistent sizing. For example, the corporate recommended size of a manager's office might be 15′×15′ but if a manager is involved in the real estate process, and more specifically the Space Program process with the space planner, that manager might ask for a 15′×20′ office.

Other consistency problems for both single and multi-location companies when finding office space comes in the area of construction detail.

For example purposes only and not by limitation, construction detail may include (either on a room by room basis or an entire premises basis): the number of various types of electrical outlets, data outlets, paint cost and colors, wall covering cost and style, cost and type of flooring (including carpet, wood, ceramic tile, VCT, etc.), plumbing, ceiling systems, special HVAC requirements, standard and custom millwork, switching mechanisms for lighting, light fixtures, audio visual requirements, telecom requirements, door type, door hardware type, partition type and any other construction detail that might typically be considered when building out interior office space.

Because of the extensive number of construction details (as briefly summarized above) that are part of a typical interior office build out, documenting and maintaining consistency of these items from office to office for Multi-location users is very difficult. Moreover, many of the items can have very wide ranges relative to price points, such as carpeting, which can vary in price to material costs of $10 per square yard to $100 per square yard. Obviously, it is very important for users to have a process that will guarantee that there will be consistency and that construction costs can be controlled.

Another problem in the office leasing process for both single location users and Multi-location users is determining the amount of construction that may be required for the build out at any building being considered by the tenant, making it difficult to estimate the actual costs associated with occupying various buildings.

Users of commercial office space will typically conduct an analysis of the costs associated with occupying different office buildings. In addition to rental rate, landlord concessions, taxes, operating expenses, utilities, build out allowances and other associated occupancy related costs, the cost of building out a tenant's space is an important part of considering which building to move to.

For example, if two buildings under consideration by a tenant have been offered identical terms by the respective landlords (or landlords' agents) but one building will cost more money for the tenant to build out than the next building, the additional cost to build out the space would make that building more expensive than the otherwise equal competitor. For example, a tenant may require 20,000 square feet at two competing buildings and each landlord has offered an equal construction allowance of $30.00 per rentable square for the tenant to build out their space. While most tenants would consider these proposals to be identical, there may actually be several hundred thousand dollars apart. This is because while the landlord has offered a construction allowance of $30.00 per square foot at each building, the tenant is responsible for construction costs that exceed that allowance. Therefore, if one building requires construction in the amount of $50 per square foot and the other building only requires $30.00 per square foot to build out their space, the tenant would have to pay an additional $400,000 to occupy the space ($20 per foot times 20,000 feet).

However, because the detail required in soliciting an accurate construction proposal is expensive and time consuming, most tenants may not make the effort to secure a construction estimate at each building being considered prior to entering a letter of intent for new space. Still, tenants may choose to make the inaccurate assumption that construction costs at each building will be basically the same.

As offered earlier, the potential difference in construction costs from building to building can be quite substantial and, if known prior to executing a lease, may alter the decision by the tenant on which building to move to (or at the very least, alter the negotiations between competing landlords).

Therefore, there exists a need for a user of office space who is either opening a new office or considering an office relocation to be able to immediately see the cost impact of various components of their Space Program, how those components fit into office buildings of various efficiencies and price points and document construction details so that accurate construction estimates can be obtained.

### BRIEF DESCRIPTION OF THE DRAWINGS

FIG. 1 is a schematic illustrating an embodiment of the system of the present invention;

FIG. 2 is a schematic illustrating the server of the system of FIG. 1;

FIGS. 3-11 and 13-17 are screen prints of displays provided by the system of FIGS. 1 and 2;

FIGS. 12A-12C illustrate a report generated by the system of FIGS. 1 and 2;

FIGS. 18A-18J illustrate portions of a National Office Standards report generated by the system of FIGS. 1 and 2.

### DETAILED DESCRIPTION OF EMBODIMENTS

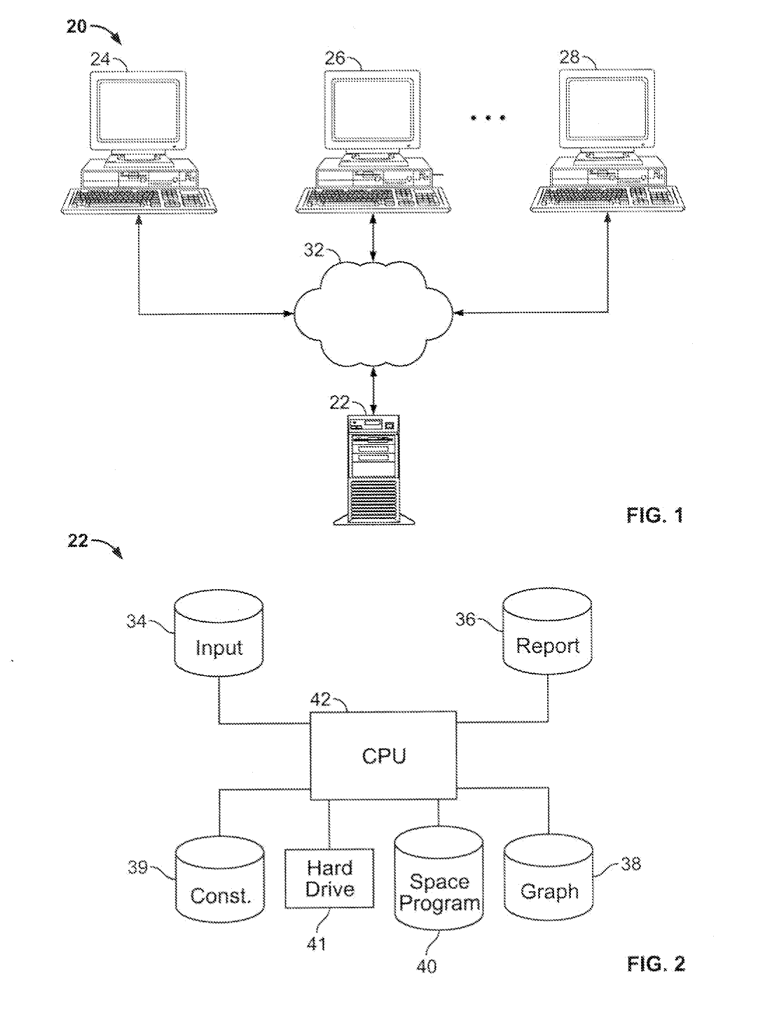

An embodiment of the system of the present invention is indicated in general at 20 in FIG. 1. The system includes a server 22 which hosts a website and associated software with the functionality as described below. A number of workstations 24, 26 and 28 featuring displays communicate with the server 22 via a network 32 such as a local area network of the Internet (using, for example, Microsoft's .NET framework and a web server). User's workstations 24, 26 and 28 may connect to server 22, for example, through ODBC (Open Database Connectivity).

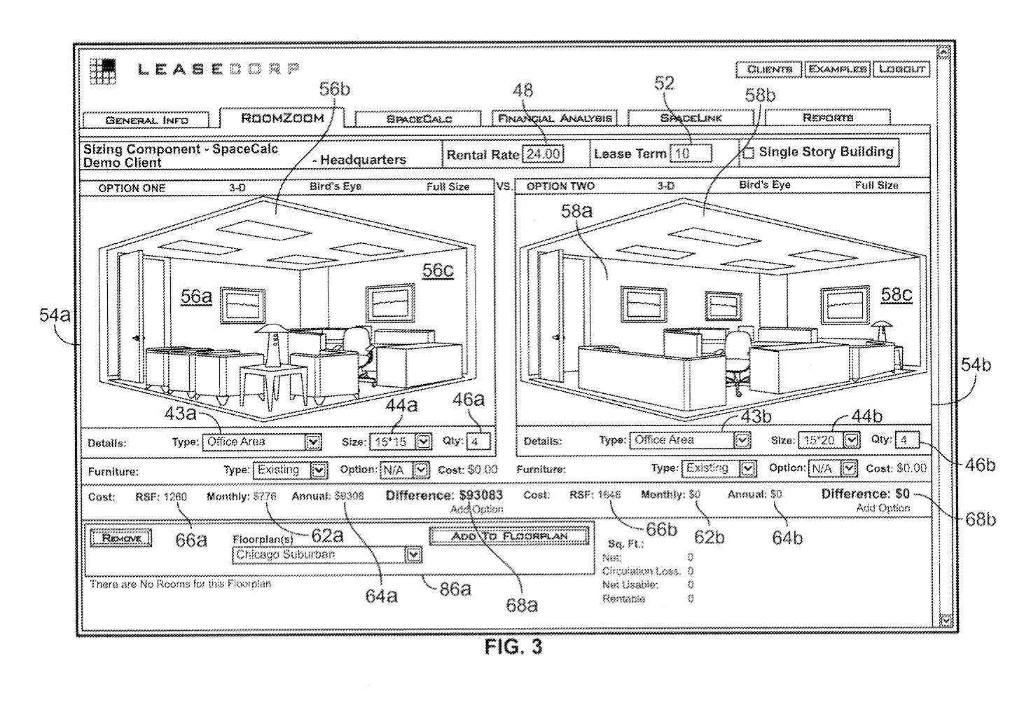

As illustrated in FIG. 2, the server, indicated in general at 22, includes input data storage 34, report database 36, graphics database 38, construction details database 39, space program database 40 and hard drive 41, all of which that communicate with one or more CPU's 42. The database arrangement of FIG. 2 is presented as an example of the system memory storage only, and the illustrated databases may be combined or alternatively grouped or divided.

The application program or software for performing the operations described below is loaded onto the hard drive 41 (FIG. 2) of the server 22. As an example only, the application may be written in Visual Basic Net with SQL Server as a data container. The formulas and code for calculating circulation factors and inefficiency factors may also be programmed in Visual Basic for Applications (MICROSOFT WORD), standard spreadsheet applications (MICROSOFT EXCEL) and standard programming languages such as SEQUEL. The data can be migrated into any compatible database. The images and displays described below may be .gif or .jpg file types produced on a workstation through AUTOCAD or COREL and uploaded to the server for storage on the graphics database 38.

As an alternative to a network system and/or a separate server and workstation architecture, the application software and databases may reside on a standalone personal computer that acts as both the server and workstation. The server and/or personal computer may include a compact disk (CD) drive so that the application software may be downloaded or run off of a CD itself. The application software may alternatively be stored on other types of machine-readable mediums.

As explained below, the system of FIGS. 1 and 2 follows predetermined phases and steps using a computer and web based software program that provides users with:

a. A method that allows them to see the immediate cost impact of various space options when creating a Space Program

b. A method that allows the user to see the immediate cost impact of various space options assuming buildings of various efficiency

c. A method that allows them to see the immediate cost impact of various space options assuming buildings of various quality and cost

d. A method that allows the user to adjust all variables that affect their eventual rental rate (area sizes within their Space Program, building efficiency and building quality/cost) so they can establish the exact requirements for their office

e. A method that allows a user to quickly create an accurate Space Program that documents the areas, sizes, quantities, estimated net usable square footage required, estimated net usable with circulation factor and estimated rentable square footage for any set of space requirements

f. A method that quickly and easily creates not only a Space Program but a list of construction items on a room-by-room basis that will be required for that Space Program so that a reasonably accurate construction estimate can be obtained

g. A method that quickly and easily creates not only a Space Program but a list of construction items on a global basis that will be required for that Space Program so that a reasonably accurate construction estimate can be obtained.

Additionally, for multi-location users, the system provides:

a. A method that allows them to see the immediate cost impact of various space options extrapolated over their portfolio when creating a global or national Space Program

b. A method that allows them to see the immediate cost impact of various space options extrapolated over their portfolio assuming buildings of various efficiency when creating a global or national Space Program

c. A method that allows them to see the immediate cost impact of various space options extrapolated over their portfolio assuming buildings of various quality and cost when creating a national Space Program

d. A method that allows them to adjust all variables that affect their eventual rental rate (area sizes within their Space Program, building efficiency and building quality/cost) so they can establish the exact requirements for their global or national Space Program

e. A method that allows them to easily create and document national Space Program standards for all area sizes within their office space portfolio

f. A method that allows them to quickly and easily create a Space Program and project the amount of space required for any office within their portfolio, regardless of the location, or space planner that will design the space

g. A method that quickly and easily creates not only a Space Program but a list of construction items on a room-by-room basis that will be required for that Space Program so that a reasonably accurate construction estimate can be obtained

h. A method that quickly and easily creates not only a Space Program but a list of construction items on a global basis that will be required for that Space Program so that a reasonably accurate construction estimate can be obtained

i. A method for a multi-location user to establish national standards for construction requirements that can easily be documented and implemented on a consistent basis from office to office within their portfolio

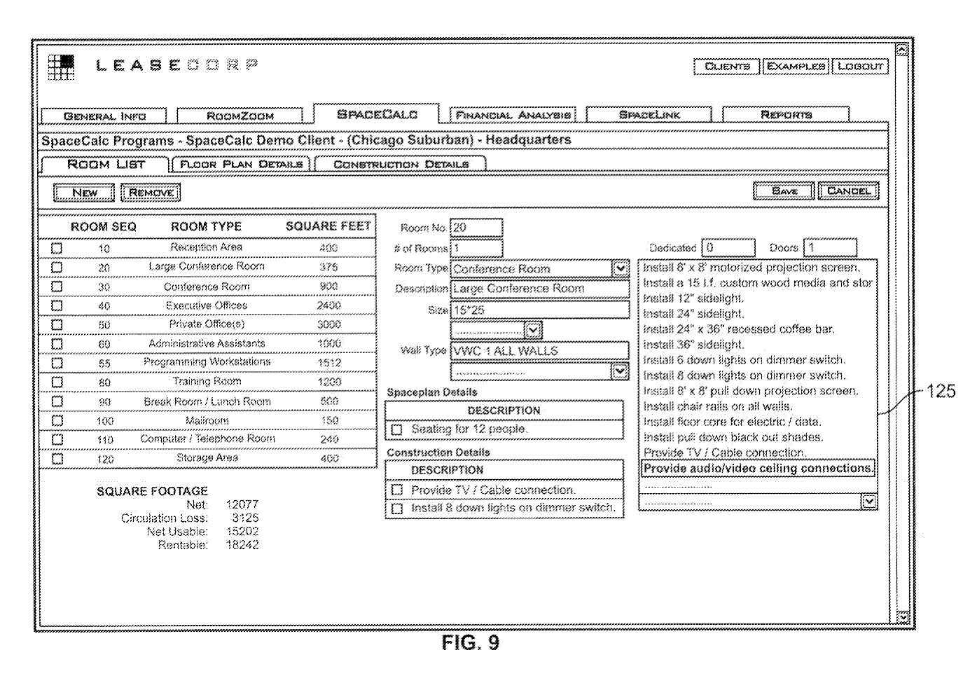

FIGS. 3-16 illustrate examples of screens that are presented to users by the system of FIGS. 1 and 2.

The system of FIGS. 1 and 2 allows a user to view images of different areas contained in a typical office environment and immediately evaluate the financial impact of eliminating or reducing the size of the area(s). The system therefore makes it easier for the user to evaluate and make decisions for all areas within their future space on an area by area basis, with visual feedback from the images of the areas and financial feedback on cost. Once the user has selected all areas within their desired space (culminating with a completed Space Program), the user can view the total list areas and the corresponding projected rentable square footage that may be required at buildings of various efficiency.

Once the projected rentable square footage is established, it can be multiplied by the anticipated rental rate for an office building that fits the user's desired quality.

The differences between net usable square feet, usable square feet and rentable square feet, which are used herein, can be confusing. For clarity, the definitions of the three are as follows:

The “Net Usable” square footage (or “net usable area”) for an area is simply the physical amount of square footage that any particular area requires. A very simply example would be a 10′×15′ private office whose net usable square footage is 150 square feet. The net usable square footage for ten (10), 10′×15′ offices would simply be 1,500 square feet.

The “Usable” square footage (or “usable area”) is the amount of measured space that a tenant actually occupies in a building taking into account the total square footage of all areas (the total net usable square footage) and accounting for circulation and ingress/egress. As mentioned before, the physical characteristics of an office building can dramatically change the amount of circulation area required for different tenants.

The “Rentable” square footage (or “rentable area”) is the usable square footage multiplied by some factor by the landlord (usually referred to as the “add on factor” or the “gross up factor”). These multipliers are the landlord's way to accommodate for the tenant's use of rentable area within the building that is common, or shared with other tenants. Some examples of common areas that are shared and used to establish these add on multipliers are common hallways, elevator lobbies, restrooms, and utility closets.

As will be explained below, to calculate the amount of estimated rentable square footage required for any individual area, group of areas or total Space Program, the system uses the systems and methods for calculating space as identified in commonly owned U.S. patent application Ser. No. 12/012,554 (“the '554 application”), the contents of which are incorporated herein by reference. Such an approach takes into consideration circulation factors and building inefficiencies in addition to a landlord's “add on factor” or “gross up factor” (dependent on whether a single tenant or multiple tenants are present) when determining the rentable square footage.

The system offers flexibility depending on the user's priority of amount of space versus quality of building. More specifically, a user can either 1) use the system to establish the quality of building that will fit into their budget given a set of space requirements that are fixed (unchangeable), 2) use the system to establish the amount of space that they can afford if the quality of building is fixed or 3) use the system to play scenarios back and forth to find the right combination of amount of space and quality of building that will fit into their budget.

The building inefficiency factor, which may be calculated in accordance with the '554 application, may specifically be used by the user in identifying building options. For example, if a user wants a certain building quality and a certain amount of space but those requirements cause projections to fall outside their budget, one alternative may be to search for buildings with a lower building inefficiency factor. Because a building's inefficiency factor directly affects the relation between net usable square footage and rentable square footage, finding a more efficient office building would allow the user to decrease its projected rentable square footage requirements and subsequently reduce its rent.

A main space evaluation screen, which is displayed on the screen of user workstations 24, 26 and 28 by server 22 of FIG. 1, is shown in FIG. 3. Using the screen of FIG. 3, a user selects an area type required in their new space via drop down menus 43a and 43b. This particular example shows a typical mid-level manager's office as the area type. The user first selects two different sizes of the same area type that is required in their space, using pull down menus 44a and 44b. In this example, they are comparing a 15′×15′ office against a 15′×20′ office. They then enter the number of areas that are required in each instance in fields 46a and 46b. In this example, they are comparing 4 of each office, although they could compare any number of offices against any other number of offices if they were interested in the associated costs of area number reduction. Lastly, they enter an anticipated average rental rate or cost of ownership per square foot (collectively referred to as “Average Rental Rate”) in field 48 and a lease term or holding period (collectively referred to as the “Term”) in field 52. This data is stored in input data storage 34 of FIG. 2.

Windows 54a and 54b provide images of with representative furniture arrangements of the area for each of the size selections and use data from the graphics database 38 of FIG. 2. The user may select alternative views of the areas by accessing icons 56a, 56b and 56c and icons 58a, 58b and 58c. More specifically, which FIG. 3 illustrates the 3-D views, birds eye (plan) and full size (full screen) views are available.

Based on the information entered in the screen of FIG. 3, and stored in input data storage 34 (FIG. 2), the system calculates the cost difference between the two options, and displays it in the screen of FIG. 3. More specifically, the cost savings on a monthly and annual basis are posted in fields 62a and 64a or 62b and 64b, respectively, for the lower cost selection. In addition, the screen of FIG. 3 gives the total cost savings over the selected term in either field 68a or 68b. As a result, the system gives a user immediate feedback and associated costs of various space options on a rentable square footage basis, with the corresponding rentable square footage provided in fields 66a and 66b of the screen of FIG. 3.

In order to display the information presented in the screen of FIG. 3, a calculation is made by the system to find the rentable square footage of each option. The rentable square footage includes not only the net usable square footage (i.e. 15′×20′=300 square feet) but also includes the circulation factor required for the area in question to arrive at a net usable square footage. As described previously, to establish the circulation factor of each area, the program loaded on hard drive 41 of FIG. 2 uses the circulation factor formula identified in the '554 application.

Next, the program multiplies the usable square footage by an efficiency ratio for the building to arrive at a rentable square footage estimate for that requirement. The efficiency ratio equals one plus the decimal equivalent of the building inefficiency factor. Preferably, the building inefficiency factor is calculated by the program as described in the '554 application. Alternatively, the program may use an estimated 20% building inefficiency factor (which provides an efficiency ratio of 1.20) as a default, but this number can easily be adjusted by the user, especially if the inefficiency factor of the subject building is known.

In the example presented in FIG. 3, the rentable square foot estimate for the first option (right window), as displayed in field 66b, is 1,648. To arrive at this number in this example, the program uses the following formula:

[(sideA*sideB)+{(square root of sideA*sideB)*½ main aisle}]*ER*# of areas

Where: sideA=length of first side of area
sideB=length of second side of area
main aisle=width of main aisle (default at 5′ but may be adjusted by user depending on preference)
ER=Building efficiency ratio (1.0+building inefficiency factor as decimal).
   As noted in the '554 application, alternative formulas are used by the program for other types of areas (for example: reception area, conference room, etc.) to take into account differing circulation requirements.

Next, the program multiplies the rentable square foot estimate by the Average Rental Rate (field 48 of the screen of FIG. 3) and the Term (field 52 of the screen of FIG. 3), both stored in the input data storage 34 of FIG. 2, to arrive at the monthly, annual and total estimated cost for that option for the Term selected. The program uses the same calculation method for both of the options.

The program next establishes the differences between the monthly, annual and total costs of each option and displays this information, as described above, allowing the user to quickly see the financial impact of each of the options. In this case, the difference of these two options over the Term, as displayed in field 68a, is $93,083.

Based on the information presented in the screen of FIG. 3, the user selects one of the options (or consider other options if desired) and adds it to a list of desired areas, which is stored in the space program database 40 of FIG. 2. The user then selects subsequent areas required by the user (i.e., conference room, break room, computer room, etc.) documenting the user's choice for each area until all requirements have been selected. Once all areas are documented, the user has a list of all area requirements for their new office commonly referred to as their Space Program.

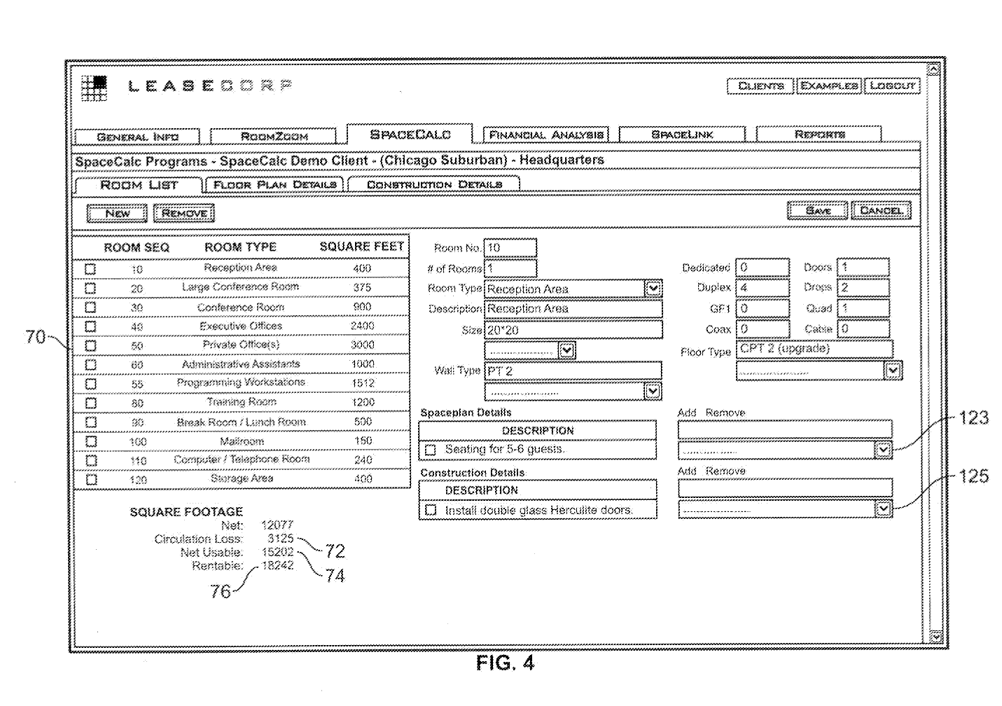

An example of a Room List display screen is provided in FIG. 4 and displays the Space Program 70 created by the user. As indicated previously, the method of the '554 application is used to determine the total circulation factor or loss, which is displayed in field 72. The combination of the square footages for all areas on the Space Program plus the total circulation factors are the net usable square footage, displayed in field 74. The program then multiplies the net usable square footage times the building efficiency ratio to establish, in field 76, the rentable square footage of space required for that Space Program in a building with an inefficiency factor, and thus efficiency ratio, that is the same as (or at least similar to) that entered by the user.

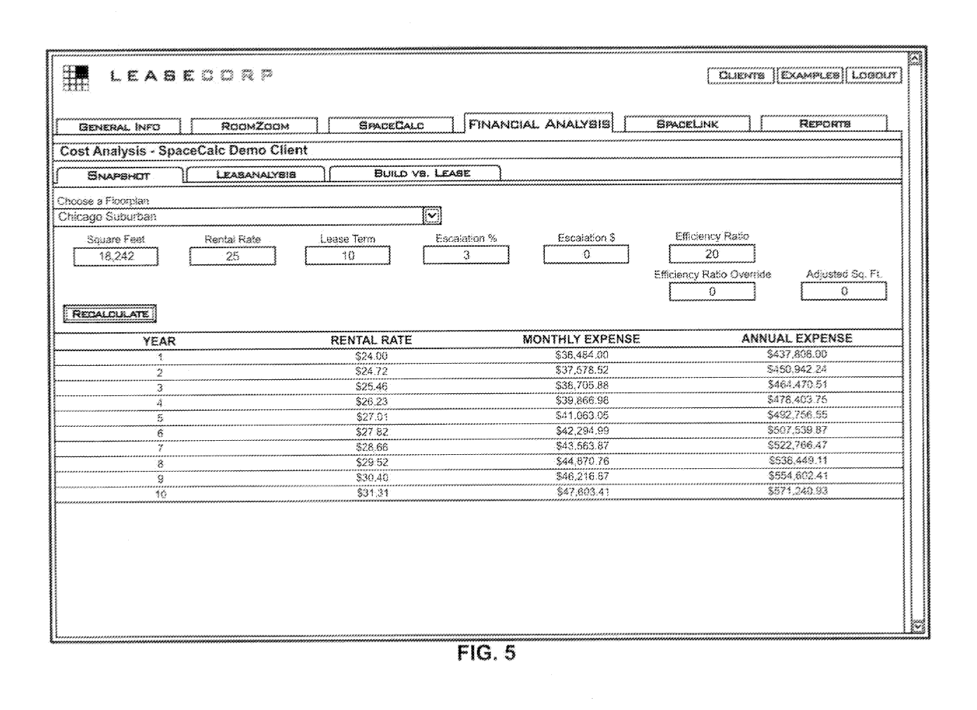

The Snapshot display screen of FIG. 5 may be accessed by the user to provide further evaluation of the Space Program displayed on the screen of FIG. 4. More specifically, the user may use the rentable square footage from field 76 of the Space Program display screen of FIG. 4, which is automatically displayed in field 82 of the screen of FIG. 5 when the user selects the corresponding floorplan title from the drop down menu 84. The title of the floorplan, which designates the Space Program of screen of FIG. 4, is established in field 86 of the screen of FIG. 3 (in this example, the user has selected “Chicago Suburban”). The corresponding building inefficiency factor is also automatically loaded into field 87 (labeled “efficiency ratio”) of FIG. 5.

The user may then enter the estimated rental rate that may be expected in a building that meets the user's quality standards in field 86 of the screen of FIG. 5. The user also enters the expected base rent increases in field 88, tax and operating expense increases in field 92 and the number of years in the term in field 94. The program calculates and illustrates a snapshot of what the rent will be over the term in section 96 of the screen of FIG. 5. Using this screen, the user may quickly identify if the projections fit within their budget.

In the case where the user's Space Program square footage and rental rate (based on building quality) create projected rent too expensive for the user's/tenant's budget, the user may adjust the search criteria in a number of different ways.

For one, the user might decide that the quality of the building could be lowered thus lowering the target rental rate and the eventual rent. As an example, a user's space requirements result in a Space Program that the program identifies will take 20,000 square feet and the user would like to be in a building that has an estimated rental rate of $25.00 per square foot. This would result in a projected annual rent of $500,000 per year. If the user had a desired budget of $450,000 annually, then they would input, into the screen of FIG. 5, different potential rent numbers until they entered a rental rate of $22.50, which would result in an annual rental rate of $450,000.

For convenience purposes, as illustrated in section 96 of FIG. 5, the program shows both the monthly to annual projected rent figures so it does not matter whether the user's budget period was per month or per annum.

Another option for the user is to adjust specific area sizes to reduce the total square footage of the Space Program, and thus reduce the eventual rent. In this instance, the user might again input into the system different scenarios to see what square footage (and related square footage reduction from the original Space Program) would be required to for the user to be in a building of the user's desired quality and price.

As an example only, the user may determine that in order to end up at a rent that fits within their budget, they need to reduce their original Space Program by 350 rentable square feet. At that point, the user returns to the screen of FIG. 3 and reviews the sizes of different areas that they might be able to reduce. They may decide that they could accept 15′×15′ offices for their four managers instead of 15′×20′ offices. For this comparison, the system analysis would show, with reference to fields 66a and 66b of FIG. 3, that that adjustment would reduce the rentable square footage from 1,648 rentable square feet to 1,260 rentable square feet (a reduction of 388 rentable square feet). Therefore, this adjustment would reduce the projected rentable square feet of the Space Program to a point that would fit into the user's budget.

The user could also adjust the relative efficiency of the target building to bring their square footage requirement into budget. As identified in the '554 application, each building has qualities that contribute to its relative efficiency, or ability to lay out a user's space in the most efficient manner possible. In the '554 application, the method of ranking buildings is reduced to a building inefficiency ratio. The higher this number is, the higher the inefficiencies and the greater the amount of square footage that will be required in that building. The building inefficiency ratios can range anywhere from 0.10 on the low end to 0.40 on the high end. The program of the system of FIGS. 1 and 2 may use a default of 0.20, which is considered a building with an average (but not great) building inefficiency factor.

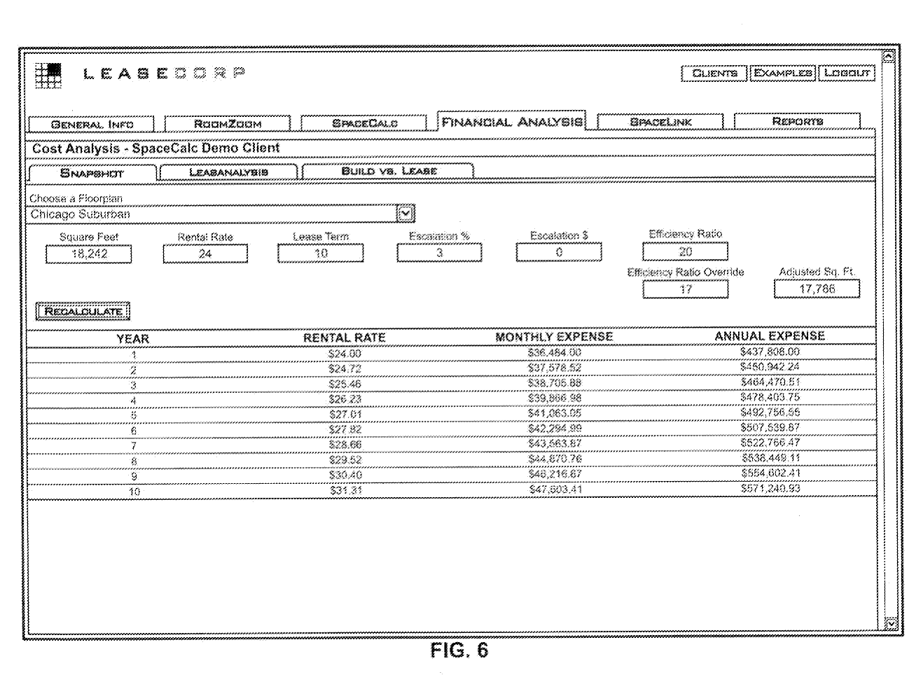

The program allows the user to manipulate this building inefficiency factor as an additional method of honing in on their desired Space Program. For example, if the user's original Space Program calls for 18,242 rentable square feet, but their budget will only allow them to occupy 17,800 rentable square feet, the user might adjust the target building inefficiency factors and realize that they would need to find a building that has a building inefficiency factor of 0.17 or less, as illustrated in field 98 of FIG. 6. This feature can also be used if the desired building and building inefficiency factor are already known. For example, if the known building's inefficiency factor is 0.24, then the user can enter that number into the field 98 of FIG. 6 and identify the square footage required given that Space Program and corresponding building inefficiency factor. This is important in cases where a high building inefficiency factor might cause the user to go out of their budget because of additional square footage required at that particular building.

Each of the evaluation options mentioned above can be used alone to help a user identify a Space Program that fits into their budget, but it should be obvious that a user may use all three of the adjustment features until they find just the right mix of area sizes, target rental rate and target building inefficiency factor to make sure that their Space Program and building alternatives will fit within their budget.

Once the final space requirements are determined, the user may then use other tools in the program to detail construction requirements that will be required for the space so that an estimate of construction costs can be secured. Construction details typically fall into two categories: 1) details that are specific to the entire space or a large part of the space (or “Global Details”) and 2) details that are specific to one area within the space (or “Area Specific Details”).

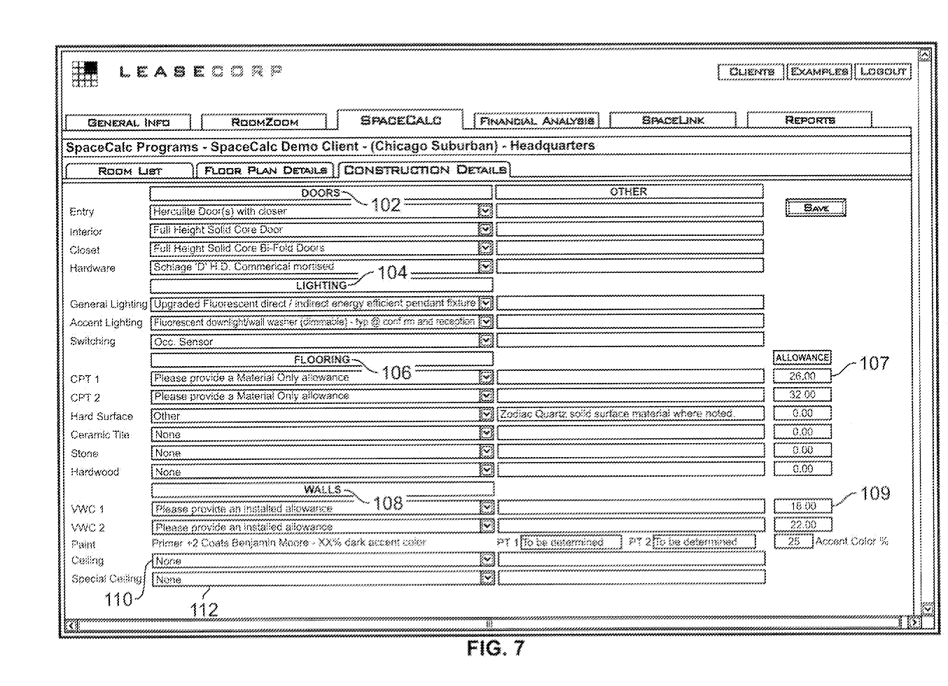

For a user to enter Global Details of their space, they go to the Construction Detail display screen, shown in FIG. 7. On this screen, the user can enter, among other things, door types, light fixtures types, various flooring options within the space (including carpet, VCT, ceramic tile, etc), wall finishes (including paint and wall covering) and ceiling treatments (including but not limited to ceiling tile or ceiling tile systems and any special ceiling treatments). This information is stored in the construction details database 39 of FIG. 2.

To enter the door details, the user selects, in the fields of section 102 of FIG. 7, the type of doors they want within the space, including entry doors, interior doors and closet doors. The program allows the user to select from a drop down list for each selection that can be populated with the most commonly selected options specific to that selection. Alternatively, if the drop down list does not include the specific selection that the user would like to enter, they can select “other” and enter and manually enter the desired construction detail.

To enter the lighting details, the user selects, in the fields of section 104 of FIG. 7, the type of lights they want within the space, including the general lighting within the space, alternate, or accent lighting within the space and the type of light switching the user would like within the space. The program allows the user to select from a drop down list for each selection that can be populated with the most commonly selected options specific to that selection. Alternatively, if the drop down list does not include the specific selection that the user would like to enter, they can select “other” and enter and manually enter the desired construction detail.

To enter the flooring details, the user selects, in the fields of section 106 of FIG. 7, what type of flooring options they want within the space, including a number of different carpet types, as well as hard surface materials and specialty flooring, (including but not limited to ceramic, stone, and wood flooring) the user would like within the space. The program allows the user to select from a drop down list for each selection that can be populated with the most commonly selected options specific to that selection. Alternatively, if the drop down list does not include the specific selection that the user would like to enter, they can select “other” and enter and manually enter the desired construction detail. Additionally, as many times these finish selections are not known by the time that preliminary pricing needs to be done, there is also an option to specify an allowance for the flooring in field 107 of FIG. 7. As an example, the user might elect to provide for a $26.00 per square yard allowance for carpeting, without specifying the actual manufacturer, style or color of the carpet. This way the user can specify the actual finish at a later date with the understanding that any carpet they selected must fall within the range specified and that if the cost of the eventual carpet selected was higher or lower in price than the allowance, a subsequent credit or charge would be expected. If the user elects to enter an allowance for any such finish, they are required to specify whether the allowance is for material only or an installed price.

To enter the wall finish details, the user selects, in the fields of section 108 of FIG. 7, what type of wall finishes they want within the space, including paints and wall coverings. The program allows the user to select from a drop down list for each selection that can be populated with the most commonly selected options specific to that selection. Alternatively, if the drop down list does not include the specific selection that the user would like to enter, they can select “other” and enter and manually enter the desired construction detail. Additionally, as many times wall covering finish selections are not known by the time that preliminary pricing needs to be done, there is also an option to specify an allowance for those coverings in the field 109 of FIG. 7. As an example, the user might elect to provide for an $18.00 per square yard allowance for vinyl wall covering, without specifying the actual manufacturer, style or color of the wall covering. This way the user can specify the actual finish at a later date with the understanding that any covering selected must fall within the range specified and that if the cost of the eventual carpet selected was higher or lower in price than the allowance, a subsequent credit or charge would be expected. If the user elects to enter an allowance for any such finish, they are required to specify whether the allowance is for material only or an installed price. If a paint color is not known, it is not as important to select an allowance, since the cost of paint does not typically vary from color to color. As it is typical to use a primer and two coats of quality paint in most commercial applications, the user only need specify whether they will want deep tone accent walls and the percentage of walls that will receive the deeper colors (as deeper tones are typically priced at a higher cost).

Lastly, to enter the ceiling details, the user selects, in the fields 110 and 112 of FIG. 7, what type of lights they want within the space, including the general ceiling tile and grid within the space and any accent ceiling finishes, such as a drywall or coffered ceiling. The program allows the user to select from a drop down list for each selection that can be populated with the most commonly selected options specific to that selection. Alternatively, if the drop down list does not include the specific selection that the user would like to enter, they can select “other” and enter and manually enter the desired construction detail. Also, the program is intended to expand to accommodate additional construction specifications should the industry require more detail or should the user desire more detail.

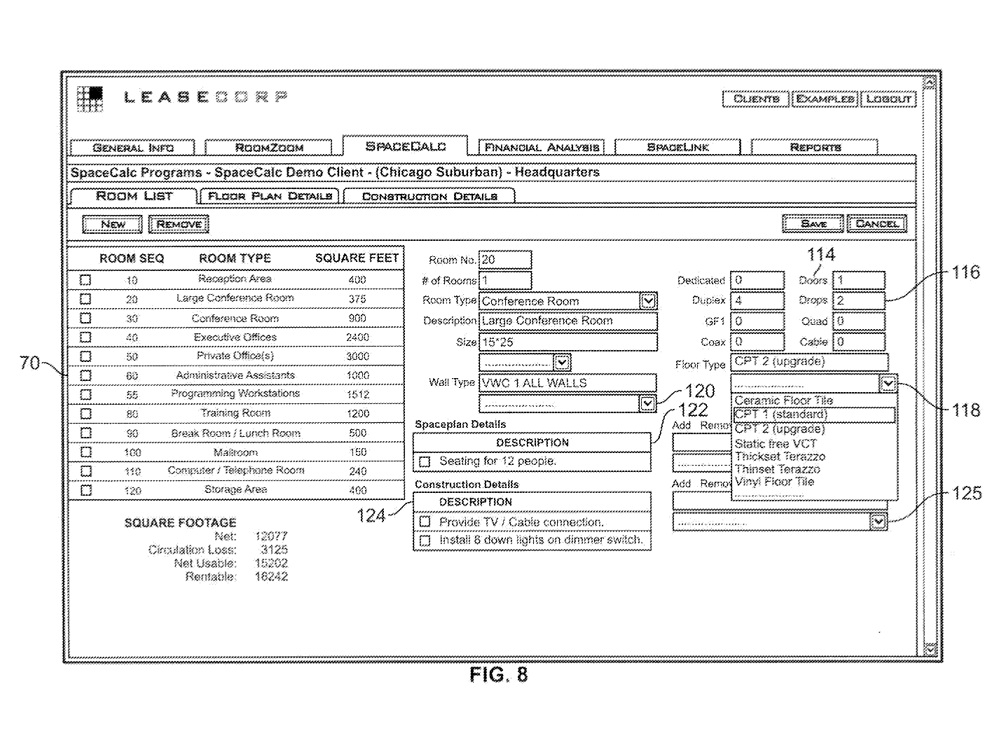

Once the global finishes selections are made, the user enters construction and design details on a room by room basis. To enter these details, the user returns to the Room List display screen illustrated in FIG. 8 (previously illustrated in FIG. 4). The list of rooms that were created in the Space Program appear (at 70) and the user selects (by clicking on) the room the user wishes to edit in terms of construction details. Upon selecting a room, the user sees the construction details for that room, illustrated in the fields to the right of the Space Program. In the example presented in FIG. 8, the user has selected the “Large Conference Room” from the Space Program.

There are a number of options for the user to enter specific construction and design direction at this point. The defaults for different types of electrical outlets, data connections and required doors for the room will automatically load from the construction database 39 of FIG. 2 into the fields in section 114 of FIG. 8. These defaults are drawn from a user interface that an authorized user can input or edit at any time and are the assumed for typical number of outlets given the size and type of room. However, it the user would like to change the quantities of any of these input fields, they may do so manually. For example, if the default number of data drops (or “Drops”) for a room calls for one, the user may change that number to two, if desired, by simply highlighting the “1” in field 116 of FIG. 8 and replacing it with a “2.”

Next, the user can select the wall and floor finishes for that particular room. To do so, the user uses the pull down menus for “Floor Type” and “Wall Type”, illustrated at 118 and 120 in FIG. 8, respectively. Here, the user selects which finish they want from the corresponding drop down menu. The program facilitates coordination of finishes between the global settings and the room detail settings. For example, the user may specify two different carpet types, CPT1 and CPT2 (in section 106 of FIG. 7) and the user may simply enter which carpet they would like in any particular room via the drop down menu 118 of FIG. 8. This saves having to reenter the full carpet specification, which can be very long, repetitively. Like the default items in the fields mentioned in the preceding paragraph, these selections are managed in a default maintenance section for authorized users.

The program also allows quick entry of notes that may be needed for space design purposes. The program lists these as “Spaceplan Details” in field 122 of FIG. 8 and may include a wide range of instructions that may be needed by a space planner to design the space. Without limitation, examples include the number of people that should fit into an area, desired adjacencies with other areas, or specific location directions (i.e. “locate on window line” or “corner office”). While the program provides a user with a list of available selections to choose from via a drop down menu, illustrated at 123 in FIG. 4, it also allows manual input of special requests that might not be common enough to put in the drop down menu.

The program also allows quick entry of notes that may be needed for construction purposes. The program lists these as “Construction Details” in field 124 of FIG. 8 and may include a wide range of instructions that may be needed by a general contractor to price the construction of the space. Without limitation, examples include millwork, plumbing, special finishes, and any other construction requirements that would not typically be assumed by a general contractor pricing the work. The intent of this section is to provide the general contractor with as much information regarding the build out of the space as possible, which leads to more accurate pricing of the required work. While the program provides the user with a list of available special construction selections to choose from via drop down menu 125, as illustrated in FIGS. 4, 8 and 9, it also allows manual input of special requests that might not be common enough to put in the drop down menu.

For both the Construction Detail section and Spaceplan Detail section, it should be noted that the program is designed so that options in each drop down menu are specific to the areas that are selected in the Space Program. For example, in the Construction Detail drop down menu for a room that is selected as a break room, some construction detail items that would appear may be “install sink with hot and cold running water” and “provide direct hook up of water line to ice maker.” However, those same construction detail items would not appear in a room listed as the reception area, as it is not typical to have a sink in a reception area. The reception area, on the other hand, may have items like “allow $10,000 for custom reception millwork” and “provide 3 down lights over corporate logo.”

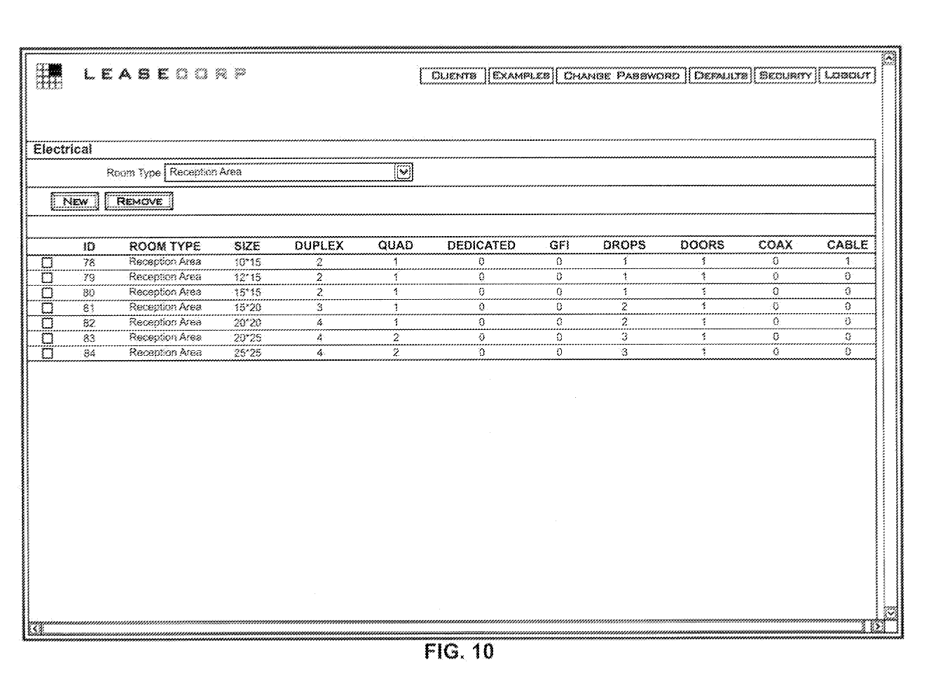

As illustrated in FIG. 10, a Maintenance display screen allows an authorized user to add new area types and sizes, but add, delete or edit all of the default items for electricity, data, floor options, wall options, construction details, space planning details and the like. This allows the manager of the program to easily update the program in the case of changing industry trends.

Once the user has entered (or selected from the drop down menus) all of the desired construction details for a chosen room, the user “saves” those details and moves to the next room to be edited via the Room List display screen (FIGS. 4, 8 and 9). The user continues this process until all rooms had been edited or modified to the satisfaction of the user.

As noted previously, the program allows the user to move easily between rooms by simply clicking on the room name. Additionally, the user may change the order of the rooms by simply changing the room sequence number in section 70 the Room List display screen of FIGS. 4, 8 and 9. For example, if the conference room is labeled as room sequence number 30, but the user would like that room to appear before the coat closet, which has a sequence number of 20, the user could simply change the conference room sequence number from 30 to 15, and the conference room would then appear before the coat closet in all reports.

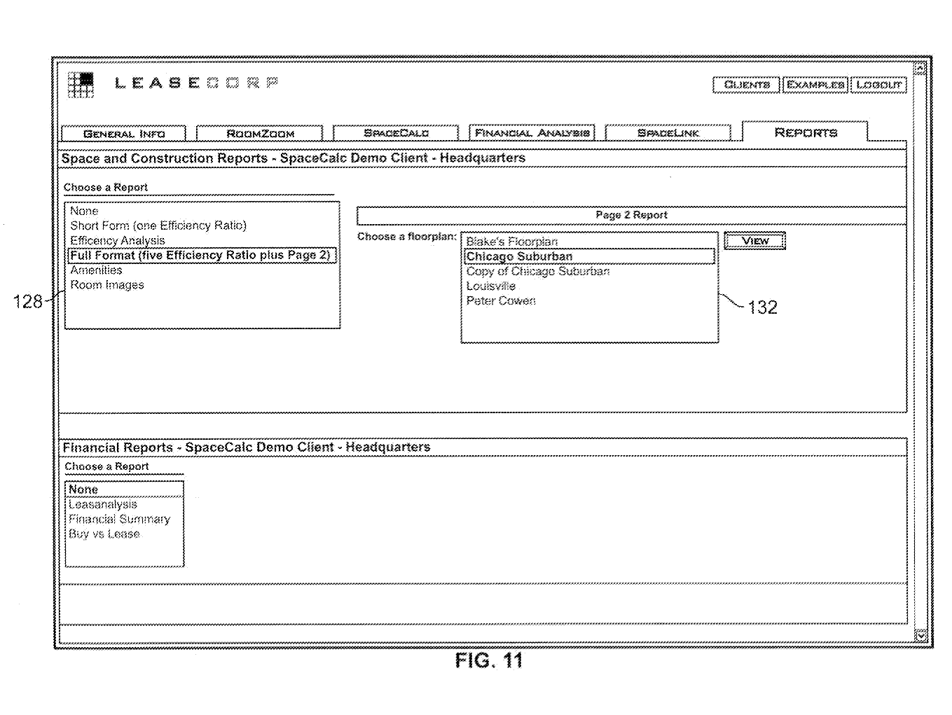

Once all global construction details, room by room details and Space Program information have been added, and thus stored in the construction details and Space Program databases 39 and 40 of FIG. 2, the user may print a report by going to the Report display screen, illustrated in FIG. 11. As shown in FIG. 11, the user selects the name of the report they would like to print from the drop down menu 128 (which communicates with report database 36 of FIG. 2) as well as the name of the floorplan (corresponding to field 86 in FIG. 3) in drop down menu 132. The report is displayed when the user selects “View” and then may be printed.

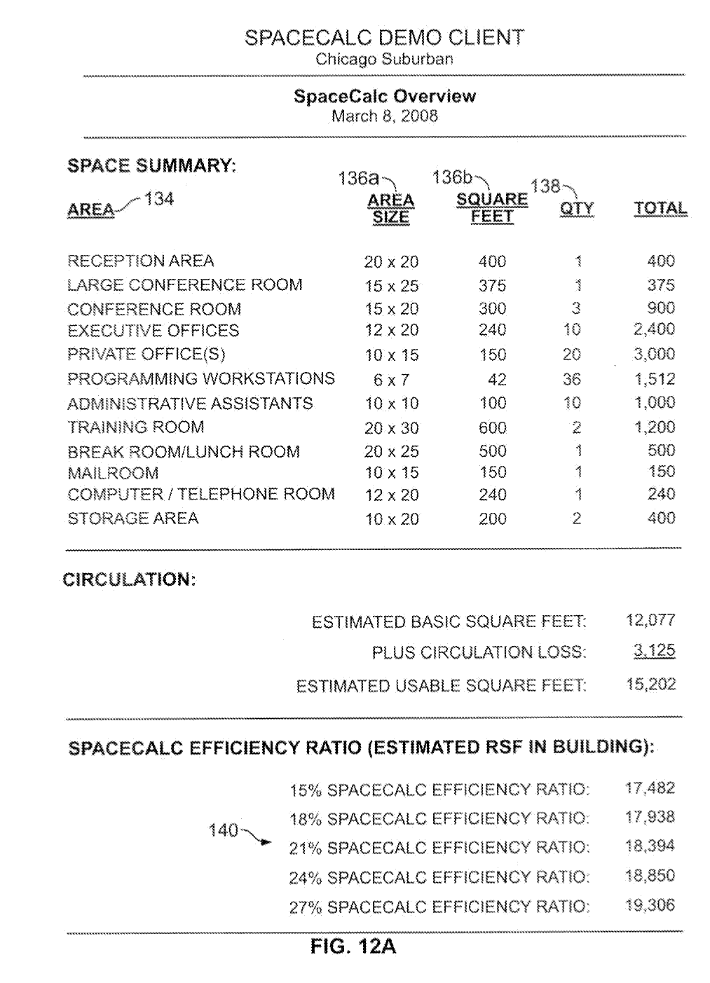

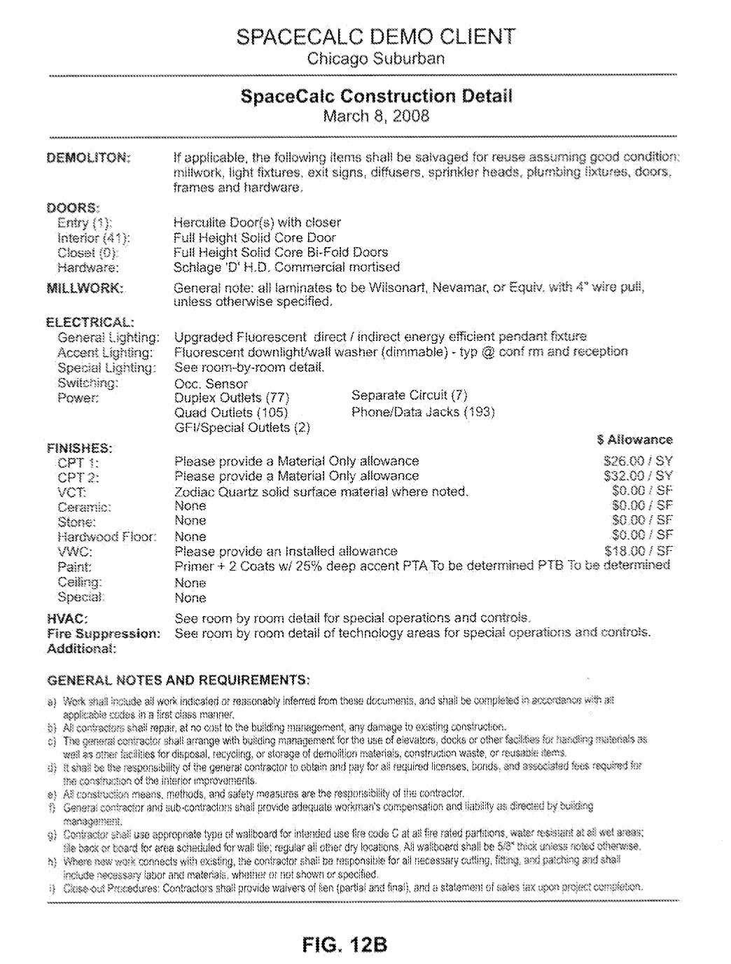

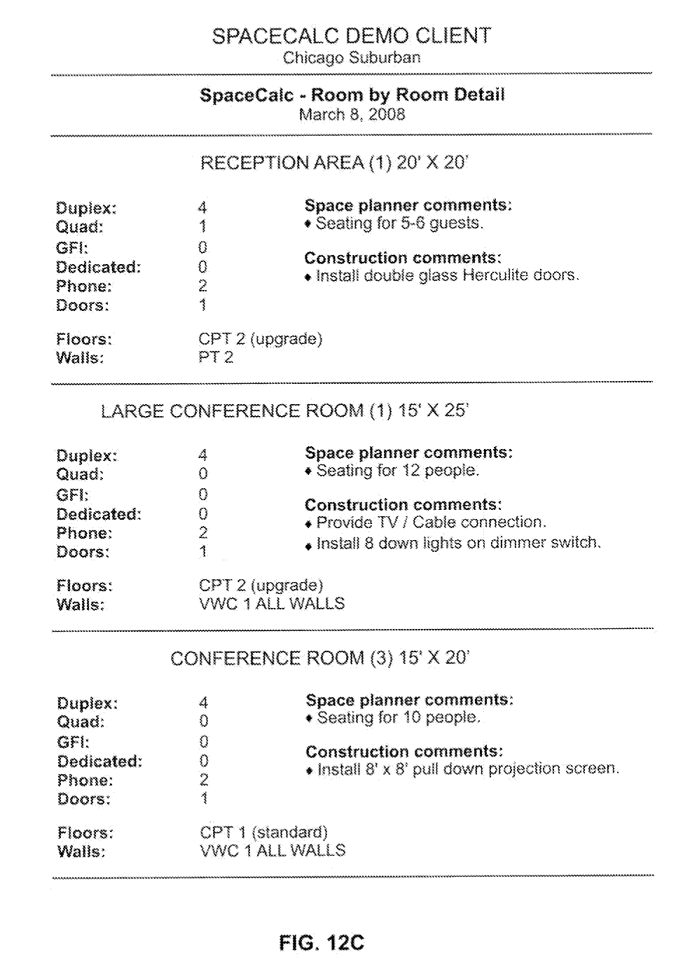

While the room images (such as illustrated at 54a and 54b on the screen of FIG. 3) and various abbreviated reports may be printed, an example of the “Full Format” report is presented in FIGS. 12A, 12B and 12C. The report contains three sections. The first section of the report is the Space Program section, illustrated in FIG. 12A. This section lists all of the specific rooms and areas within the space (134), as well their sizes (136a and 136b) and quantities (138) and their totals. In addition, the information displayed in fields 72 and 74 of FIG. 4 is displayed and printed. The program also displays and prints the estimated rentable square footage if the building inefficiency factor is known. Alternatively, when the building inefficiency factor is not yet known, the report gives a range of estimated rentable square footages based on a range of different building inefficiency factors, as indicated in general at 140.

The second section of the report, illustrated in FIG. 12B details all of the global construction information of the space. Although the room by room detail section of FIG. 12C shows the number of doors, outlets and data connections, the global construction detail information also summarizes this information for ease of use to the general contractor.

The last section of the report, illustrated in FIG. 12B, is the room by room detail section of the report. This section highlights each room's specific construction and design information.

The comprehensive report of FIGS. 12A-12C can be used at several different points in a typical real estate transaction. First, it can be used before searching for available space to project the correct amount of space required for the user, with adjustments in space requirements based on various building efficiencies. Once a target building has been identified and the target building has been measured for its building inefficiency factor, an alternate report can be produced that calculates the estimated square footage based on a that building's inefficiency factor. Once the target building(s) have been identified, the report gives space planner instructions regarding the number and sizes of rooms and areas, space planning details and the estimated square footage that should be required to design the space. After the space plans have been created, the report can be used to solicit construction estimates from a general contractor. For this purpose, the report would typically be delivered to the general contractor along with the space plan designed by the space planner.

For each of the stages above, the report brings value to the user. By projecting the correct amount of space for lease or purchase, a user can accurately identify buildings that will (or won't) fit into their budget and adjust accordingly. Next, the detail in the report not only makes it easier for the space planner to create a space plan, but ensures the client that the space is being designed efficiently and within the amount of space projected by the program. Lastly, the report allows the user to solicit an accurate construction estimate that can be used during lease negotiations with the target landlord(s).

While the system clearly has the above benefits on a location-by-location basis, there are additional benefits and conveniences for multi-location users.

Companies that have multiple locations often face additional challenges in trying to set up their offices. First, the larger the number of offices, the more difficult it is to manage the space allocation process. This is because the more locations (and respective transactions) a company has, the greater the number of variables that come into play. For example, it would be unlikely that one space planner would do all the work for the company. In fact, there may be many different space planners involved in designing the various spaces and possibly even a different space planner for each location. Also, there is currently no system for easily documenting company standards for area sizes, employee sizes, construction detail and the like.

Even for companies that have documented space allotment for various office areas, multi-location companies find it difficult to consistently translate the space usage from their internal documentation and into a location specific Space Program. This is because the process to create a thorough Space Program and detailed construction requirement list is tedious and time consuming. Also, as noted previously, even if the Space Program is accurate and in accordance with the company's space usage manual or documentation, there is no current method of accurately calculating how much space should actually be required given any Space Program.

Therefore, there is an additional need for multi-location users to quickly and easily generate the same detailed space and construction report without having to “reinvent the wheel” with each location. The program of the system accommodates such a need by providing a number of display screens specifically for multi-location users.

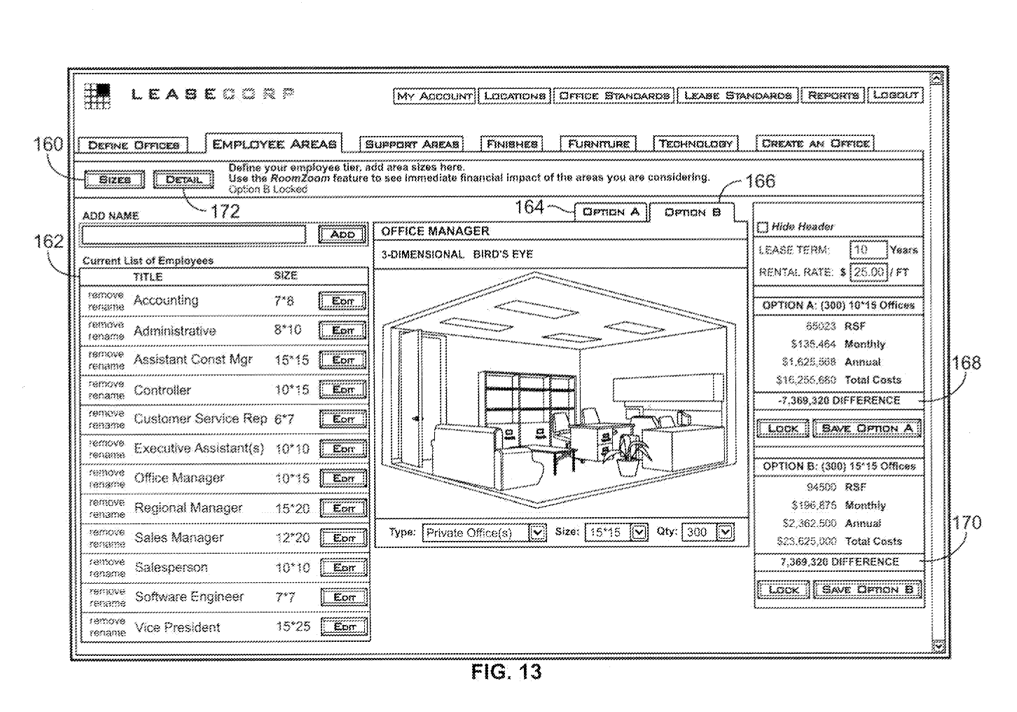

FIG. 13 illustrates the Employee Areas display screen of the system. A user may view and select area sizes for each employee function by first clicking on the “Sizes” button 160. The user may then click on the appropriate employee function in section 162 (“Office Manager” has been selected in FIG. 13), at which point a corresponding area image will be presented in the middle portion of the screen, respectively. A first size may be entered for the Option A tab 164, and a second size may be entered for the Option B tab 166, and the corresponding images may be toggled between by alternatively selecting tabs 164 and 166. The differences between the options are displayed on the right portion of the screen, as illustrated in FIG. 13. As a result, and like the space comparison feature for a single location user, multi-location users can also weigh the cost difference between different size areas for employees.

Because the system is now being used to consider multi-location impact, the cost impact is exponentially increased over a single user considering space options. For example, a corporate client might have 300 Office Managers across the country and may want to consider the cost impact of a 10′×15′ office versus a 15′×15′ office. As identified in fields 168 and 170 of FIG. 13, this one change, if implemented globally, will either cost or save the user over $7,369,320 on a ten year lease.

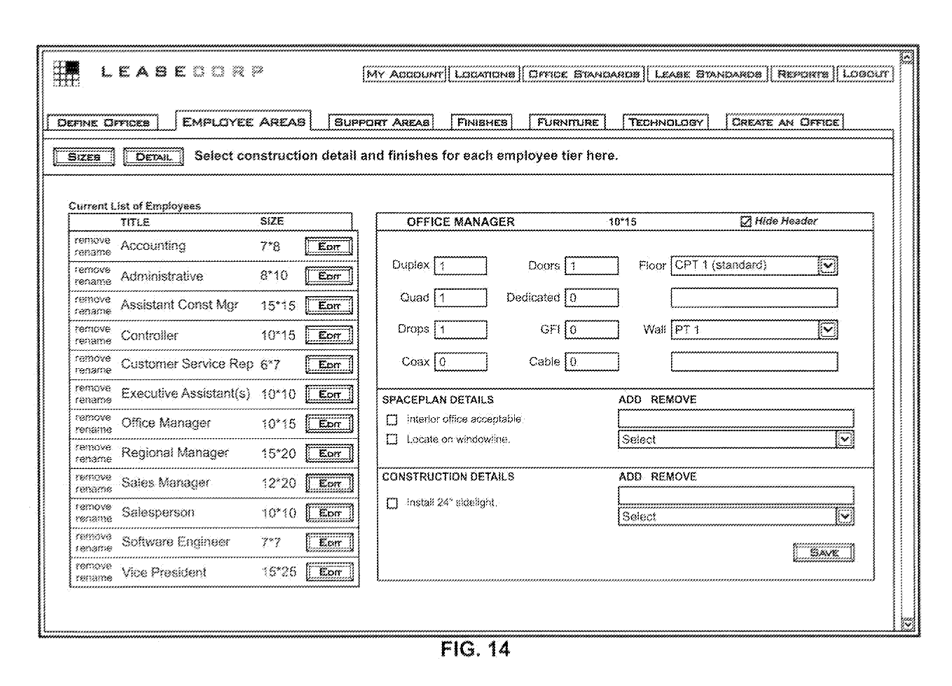

After establishing all the employee area sizes, the user may establish the construction detail on an area-by-area basis for each employee function by first clicking on the “Detail” button 172 of FIG. 13. The screen of FIG. 14 will then be displayed for the selected/highlighted employee type (“Office Manager” in FIG. 14). The user then proceeds by following the same process that single location users do, described above with respect to FIGS. 7-9. The user continues the process until all employee construction and space planning details have been entered.

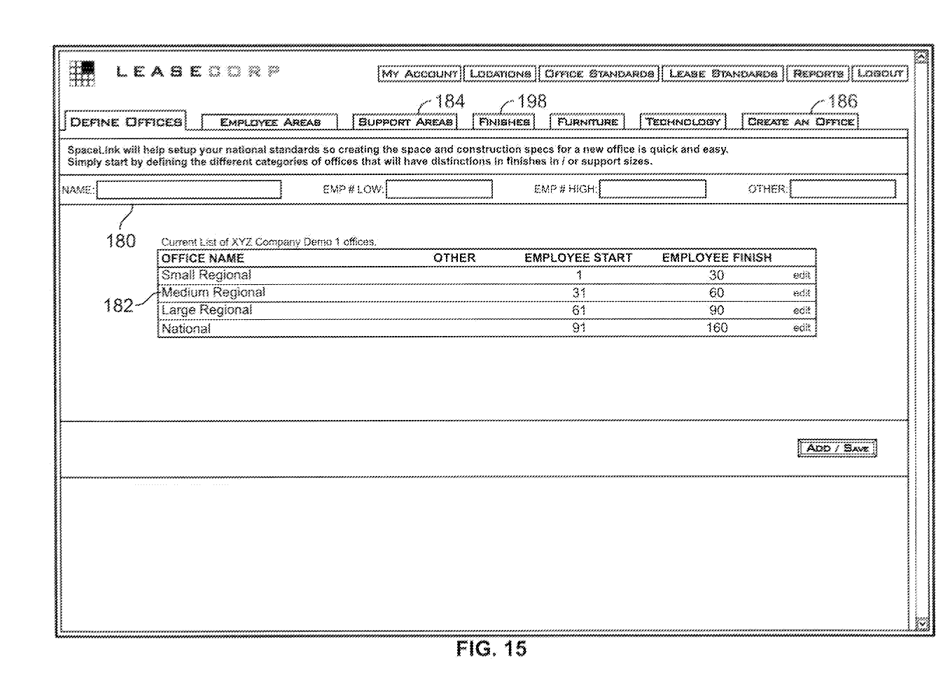

The user may use the screen of FIG. 15 to establish the range of different office sizes within their organization. For the purposes of reporting and the functionality of the program, the offices are defined by the range of number of employees that would be in any given office category or name. The reason for this is so the guest and support areas required can be calculated on a total employee basis. For example, an office that has 20 employees may require:

a. (1) 15′×20′ reception area

b. (1) 10′×20′ conference room,

c. (1) 15′×15′ break room

d. (1) 10′×15′ copy/fax area

While an office that had 40 employees might require:

d. (1) 20′×20′ reception area

e. (2) 15′×20′ conference room,

f. (1) 15′×25′ break room

d. (1) 15′×20′ copy/fax area

With that in mind, the user enters a new office category or “Office Name” in field 180 of the screen of FIG. 15 each time they want the guest and support areas to change, either from a size or construction standpoint. The program can support a large number of Office Names and corresponding sizes, which are listed in section 182 of the screen of FIG. 15 as they are entered.

Once the different Office Names have been entered in the screen of FIG. 15, the user establishes the size and number of guest areas and support areas for each Office Name or category. More specifically, the user selects the guest and support areas that will be required for each Office Name by highlighting the appropriate Office Name or category at 182 and selecting the “Support Area” tab 184 of the screen of FIG. 15. The user continues the process by selecting the number and size of the guest and support areas using the process described above to select, size and detail areas for single location users until all guest and support area sizes, construction and space planning details had been entered for all areas for all offices.

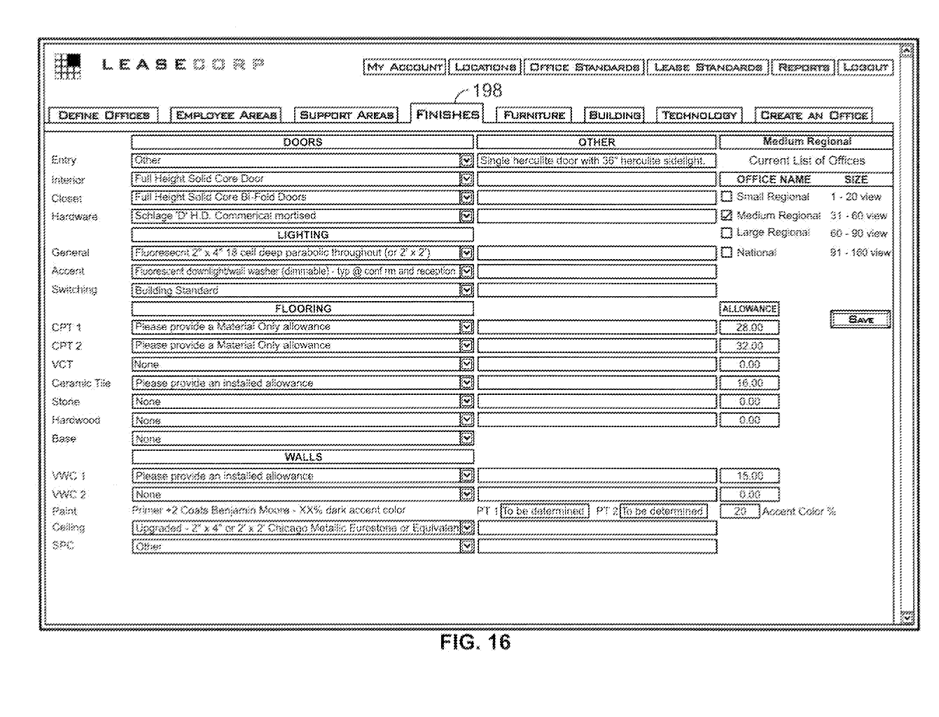

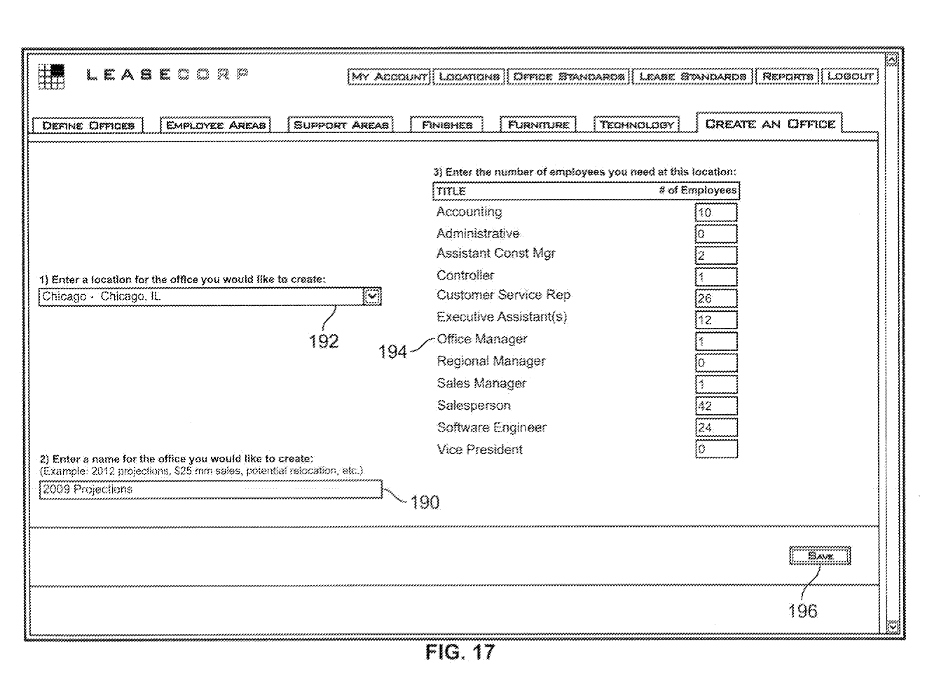

The user may also select the Global Details for finishes/construction for the office using the Finishes tab 198 of the screens of FIG. 15. More specifically, when the Finishes tab of screen 15 is selected, after one of the Office Names or categories at 182 in the screen of FIG. 15 has been highlighted, the screen of FIG. 16 is displayed. The user may then proceed as described above with regard to FIG. 7.

Once all of this information has been entered, the user can then build an office by simply entering the number of employees required at that location. To do this, the user selects the “Create an Office” tab 186 of the screen of FIG. 15. The screen of FIG. 16 is then displayed. The screen of FIG. 16 requires the user to enter the name of the office (not to be confused with the “Office Name” of FIG. 15) and the location of the office they would like to create a Space Program and construction detail for in fields 190 and 192, respectively.

The user next simply enters the number of each “type” of employee required at that location in the fields of section 194 of the screen of FIG. 16. Employee types with no quantity next to their name will simply not show up on any final reports and will not be used in any calculations. The user may then save the entries by selecting the same button 196 of the screen of FIG. 16.

Once the data entered and saved using the screen of FIG. 16, the program determines the number of guest and support areas required based on the total number of employees in that office and the standard established for the corresponding Office Name (established using the Support Areas tab 184 of FIG. 15). As an example, if the number of employees is 120, the office would fall into the “National” name or category because that range has been identified as 100 to 150 employees. The number, size and construction details of the guest and support areas would then equal what was previously established for that Office Name (category) as well as the global construction details for that Office Name or category.

Next, the program calculates the amount of total net usable, usable and rentable square footage for the office using the method and calculations of the '554 application as described above. The amount of rentable space required for a range of buildings of various efficiency ratios may also be calculated as described above using the method and calculations of the '554 application. The program can also generate the report of FIGS. 12A, 12B and 12C for the office.

Once the original office types, employee sizes, guest sizes, support sizes, room by room space plan and construction detail, and global construction detail have been entered, the user can generate a report in seconds that without the software could previously take days, weeks or even months (depending on the size) to generate.

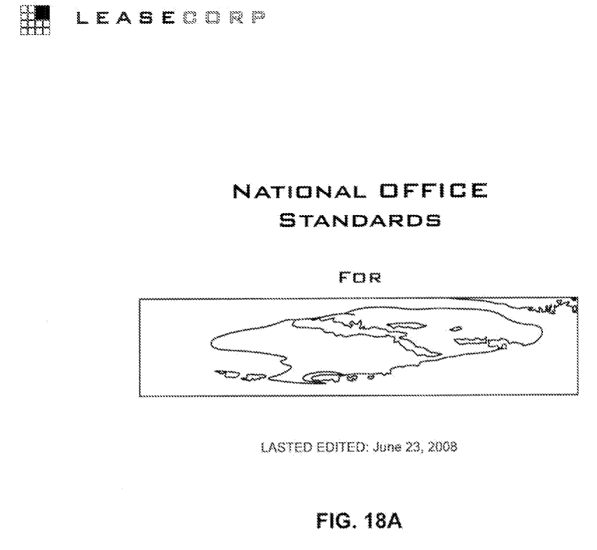

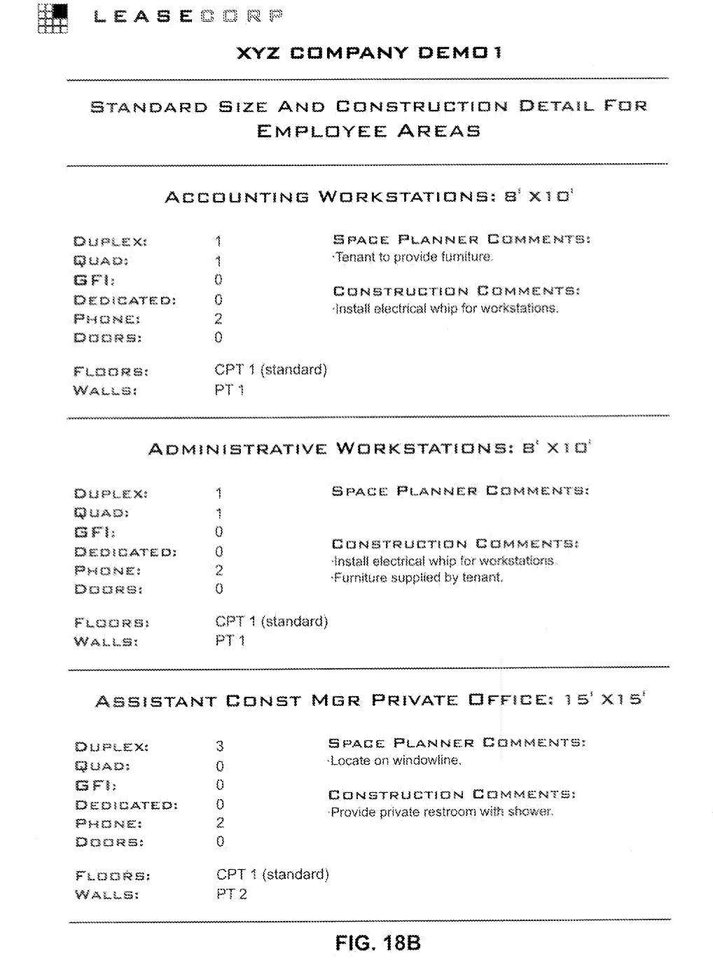

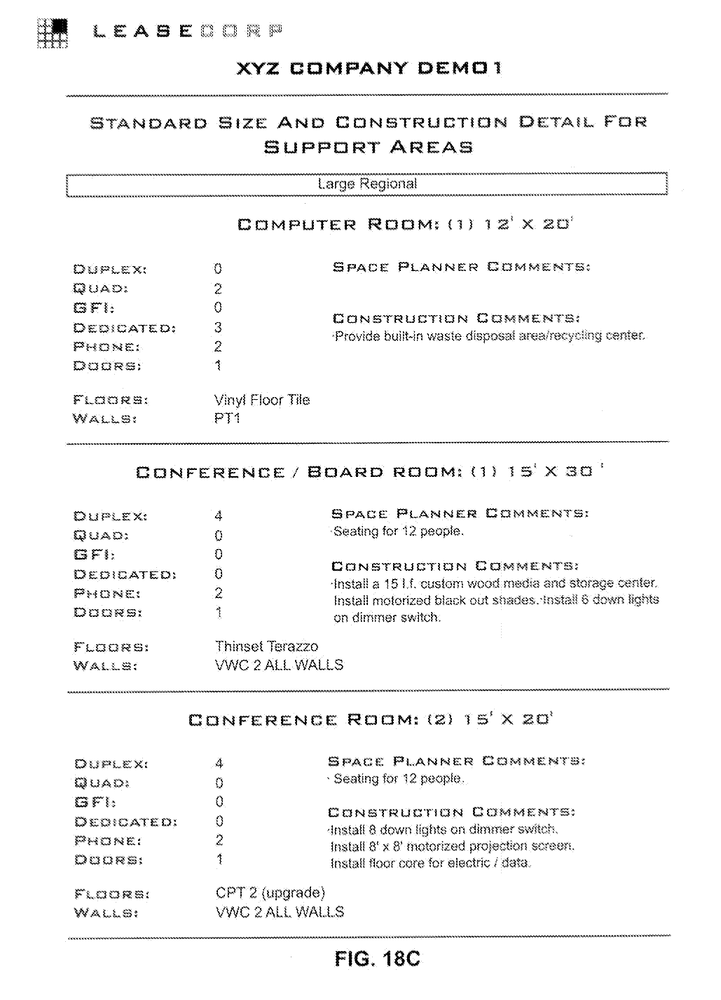

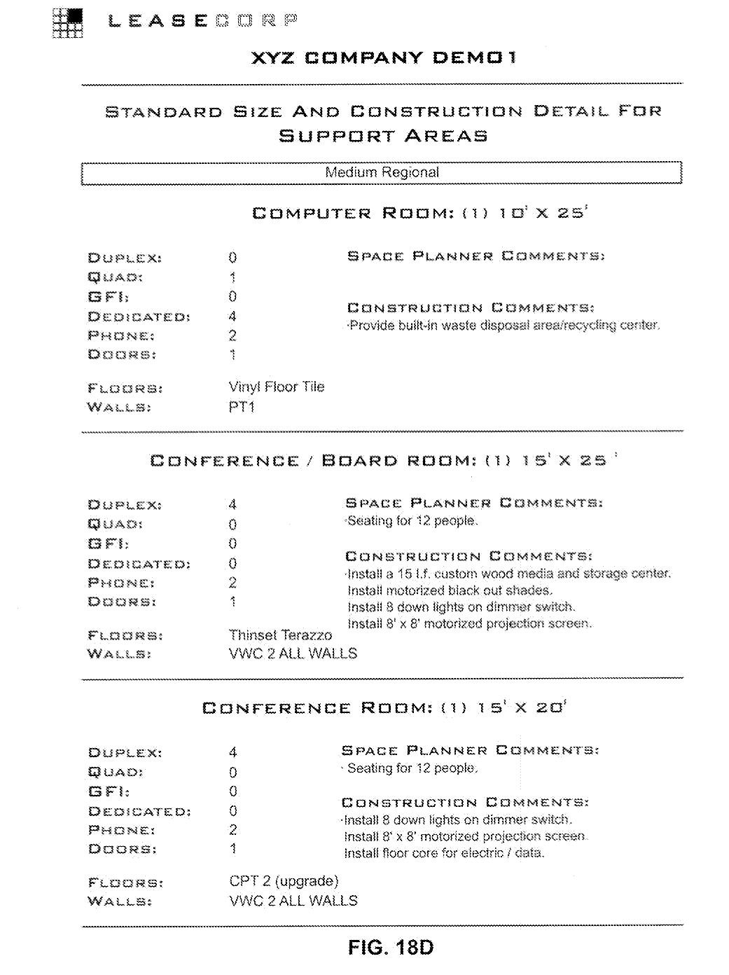

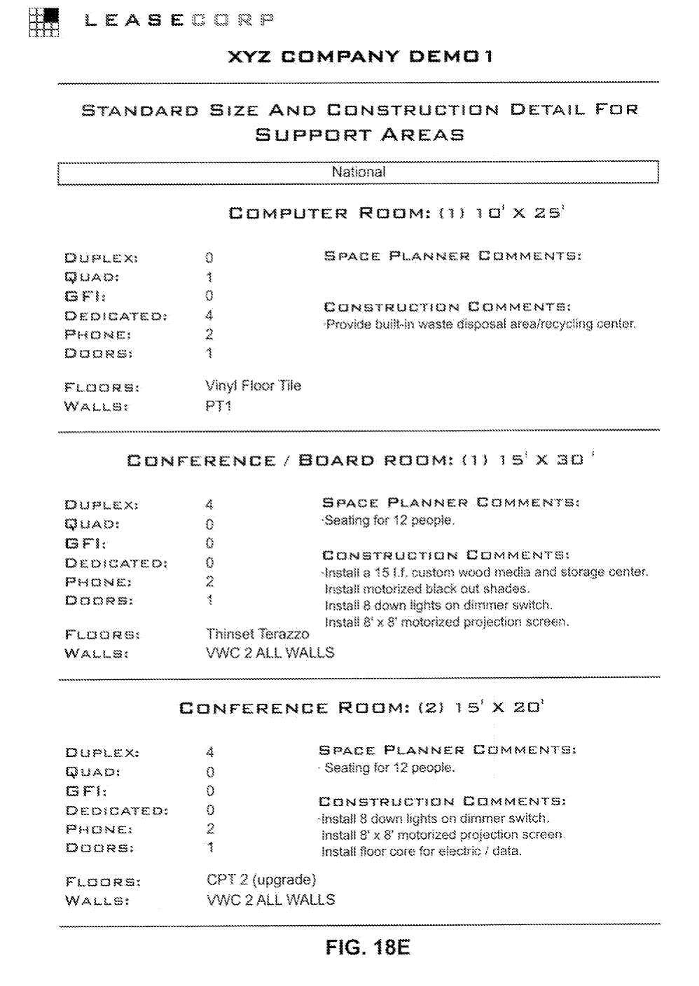

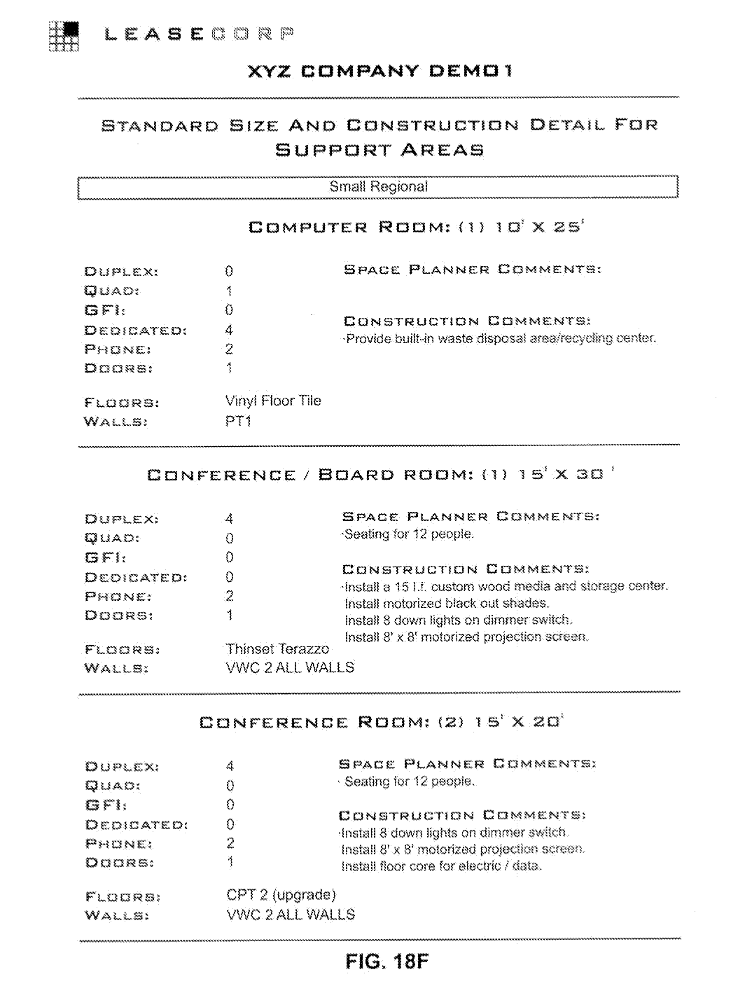

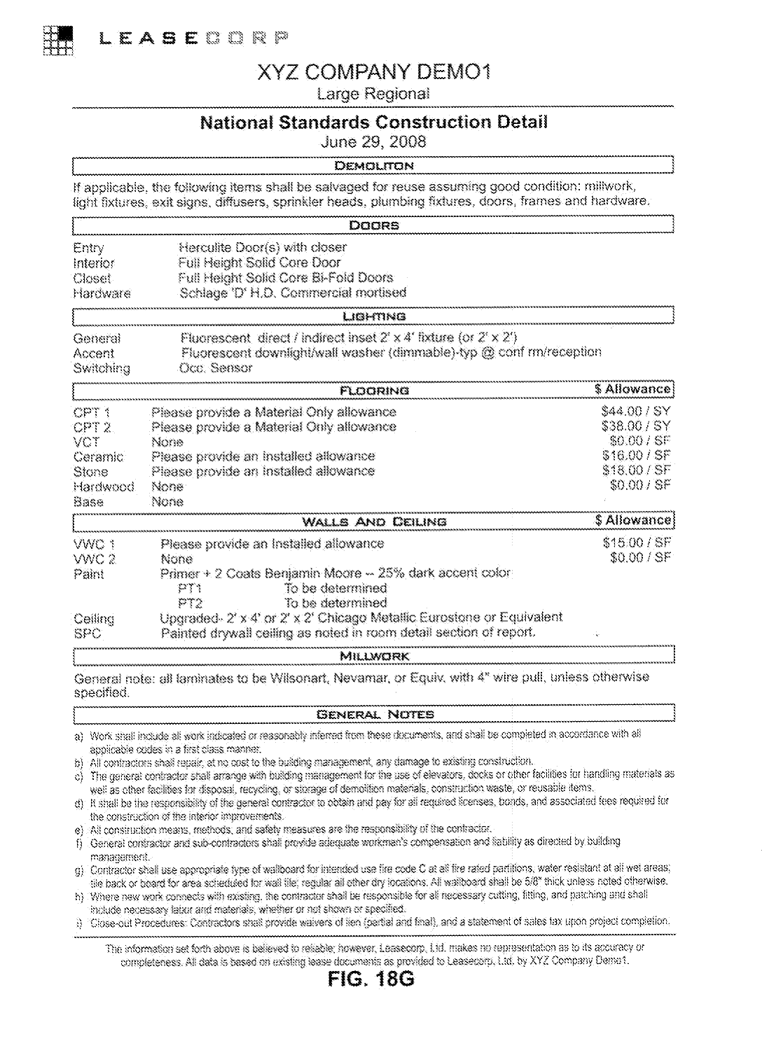

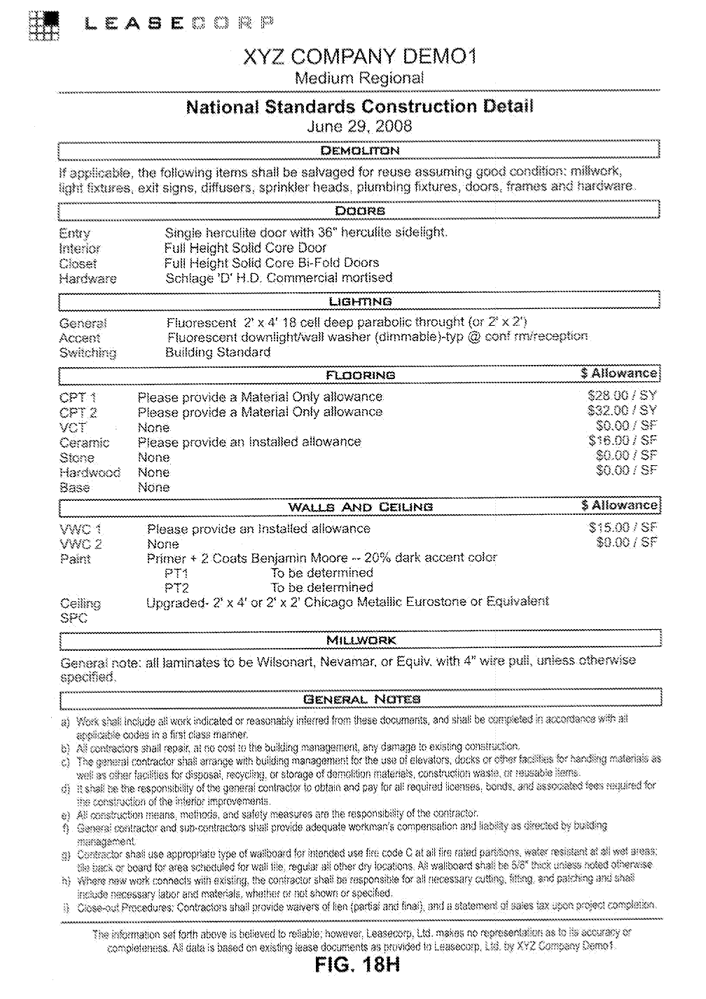

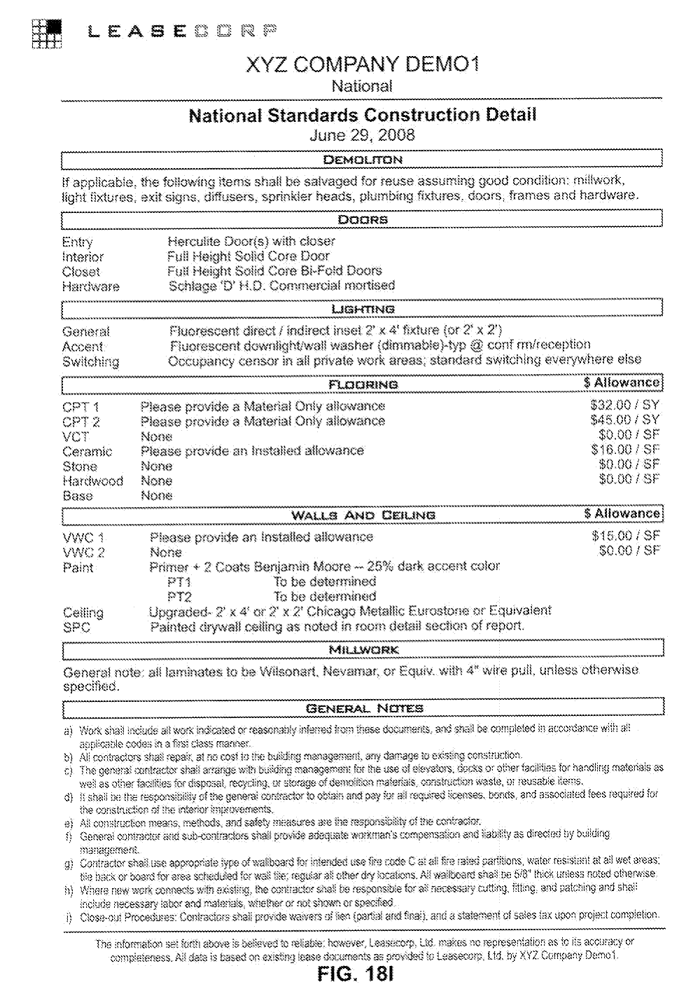

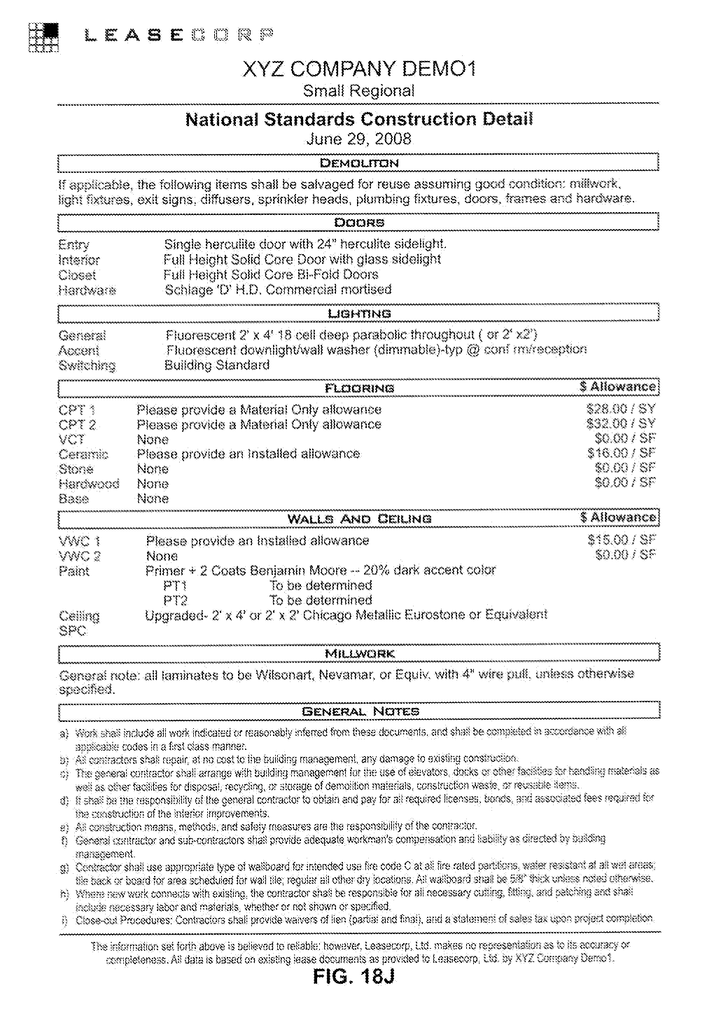

It should be noted that the settings are saved for any multi-location user, making it easy to change or update the corporate standards at any time. Additionally, the program allows the user to print a report that itemizes all the national standard selections that have been selected in cases when a hard (or electronic) copy of the standards is required. Examples of portions of this report are presented as FIGS. 18A through 18J.

While the preferred embodiments of the invention have been shown and described, it will be apparent to those skilled in the art that changes and modifications may be made therein without departing from the spirit of the invention, the scope of which is defined by the appended claims.

What is claimed is:

1. A system for evaluating space requirements for a user in a building comprising:
a. a workstation;
b. a server in communication with the workstation, said server having software and memory storage which permits a user to input a rental rate, an area type and first and second area sizes for the area type through the workstation, said software comparing the first and second area sizes including an impact on rent payments for a time period based on the choice between the first and second area sizes.

2. The system of claim 1 wherein the software creates a space program from selected area sizes.

3. The system of claim 2 wherein the software calculates a usable area based on the space program.

4. The system of claim 3 wherein the software calculates a net usable area based on the space program.

5. The system of claim 4 wherein the software calculates a rentable area based on the space program.

6. The system of claim 5 wherein the software uses a building inefficiency factor and a circulation factor to calculate the rentable area.

7. The system of claim 2 wherein the software receives a number of areas of a predetermined area type input by the user through the workstation, said software including the number of areas when creating the space program.

8. The system of claim 1 wherein the software receives a term of the lease and calculates the difference in cost for the term based on the user's area size selections.

9. The system of claim 1 wherein the software receives construction details for an area type through the workstation and further comprising a construction details database in communication with the server, said construction details database storing the construction details for the area type.

10. The system of claim 1 wherein the software receives construction details for an office made up of areas and further comprising a construction details database in communication with the server, said construction details database storing the construction details for the office.

11. The system of claim 1 wherein the software receives a term and a number of areas of a predetermined area type input by the user through the workstation and includes the number of areas when calculating the impact of the user's area size selections for the predetermined area type on the user's monthly and annual rent payments and total lease cost over the term.

12. The system of claim 1 wherein the software creates a space program from selected area sizes, calculates a usable area, a net usable area and a rentable area based on the space program and produces a report displaying this information.

13. The system of claim 12 wherein the software receives construction details for an office made up of the space program through the workstation and further comprising a construction details database in communication with the server, said construction details database storing the construction details for the office and displays them on the report.

14. The system of claim 12 wherein the software receives a number of inefficiency factors through the workstation and adjusts the rentable area based upon the inefficiency factors and displays the adjusted rentable areas on the report.

15. The system of claim 1 wherein the software receives a number of office locations through the workstation and the comparison between the first and second office area sizes is made on a multi-location basis.

16. A method for evaluating space requirements for a user in a building comprising the steps of:
a. receiving a rental rate, an area type and first and second area sizes for the area type from the user;
b. comparing the first and second area sizes including an impact on rent payments for a time period based on the choice between the first and second area sizes.

17. The method of claim 16 further comprising the step of creating a space program from selected area sizes.

18. The method of claim 17 further comprising the step of calculating a usable area based on the space program.

19. The method of claim 18 further comprising the step of calculating a net usable area based on the space program.

20. The method of claim 19 further comprising the step of calculating a rentable area based on the space program.

21. The method of claim 20 wherein the rentable area is calculated using a building inefficiency factor and a circulation factor to calculate the rentable area.

22. The method of claim 20 further comprising the step of receiving a number of inefficiency factors and adjusting the rentable area based upon the inefficiency factors.

23. The method of claim 17 further comprising the step of receiving a number of areas of a predetermined area type and including the number of areas when creating the space program.

24. The method of claim 16 further comprising the step of receiving a term of a lease and calculating a difference in cost for the term based on the user's area size selections.

25. The method of claim 16 further comprising the step of receiving construction details for an area type and storing the construction details for the area type.

26. The method of claim 16 further comprising the step of receiving construction details for an office made up of areas and storing the construction details for the office.

27. The method of claim 16 further comprising the step of receiving a term and a number of areas of a predetermined area type and including the number of areas when calculating the impact of the user's area size selections on the user's monthly and annual rent payments and total lease cost over a term.

28. The method of claim 16 further comprising the steps of creating a space program from selected area sizes, calculating a usable area, a net usable area and a rentable area based on the space program and producing a report displaying this information.

29. The method of claim 28 further comprising the steps of receiving construction details for an office made up of the space program and displaying them on the report.

30. The method of claim 28 further comprising the steps of receiving a number of inefficiency factors and adjusting the rentable area based upon the inefficiency factors and displaying the adjusted rentable areas on the report.

31. The method of claim 16 further comprising the step of receiving a number of office locations and performing the comparison of step b) on a multi-location basis.

32. The method of claim 16 wherein the area type is a type of employee area and further comprising the steps of:
c. storing a selected area size for the type of employee area.
d. storing categories based on predetermined employee counts;
e. storing additional area types and sizes associated with each category of step d;
f. receiving a number of employees from the user;
g. determining the category, and thus the additional area types and sizes, corresponding to the number of employees from step f; and
h. calculating a rentable area based on the selected area size for the type of employee area from step c. and the additional area sizes from step g.

33. The method of claim 32 wherein the additional area types include support and guest areas.

34. The method of claim 16 wherein the area type is a type of employee area and further comprising the steps of:
c. storing a selected area size for the type of employee area.
d. storing categories based on predetermined employee counts;
e. storing additional area types, sizes and construction details associated with each category of step d;
f. receiving a number of employees from the user;
g. determining the category, and thus the additional area types, sizes and construction details corresponding to the number of employees from step f;
h. calculating a rentable area based on the selected area size for the type of employee area from step c. and the additional area sizes from step g; and
i. producing a report displaying the rentable area from step h. and the construction details from step g.

35. The method of claim 34 further comprising the step of receiving a plurality of inefficiency factors and adjusting the rentable area based upon the plurality of inefficiency factors and displaying the adjusted rentable areas corresponding to each inefficiency factor.

36. The method of claim 34 wherein the additional area types include support and guest areas.

37. A machine-readable medium upon which has been pre-recorded a computer program which, when executed by a computer, performs the steps of:
a. receiving a rental rate, an area type and first and second area sizes for the area type;
b. comparing the first and second area sizes including an impact on rent payments for a time period based on the choice between the first and second area sizes.

38. The machine-readable medium of claim 37 wherein the computer program receives a lease term and calculates the difference in cost for the lease term based on the user's area size selection.
